(19) United States
(12) Patent Application Publication
(10) Pub. No.: US 2012/0144296 A1
(43) Pub. Date: Jun. 7, 2012

(54) DIGITAL PLAQUE THAT DISPLAYS DOCUMENTS AND UPDATES PROVIDED BY A PLAQUE MANAGEMENT SERVER

(76) Inventors: Bindu Rama Rao, Laguna Niguel, CA (US); Madhavi Jayanthi, Laguna Niguel, CA (US)

(21) Appl. No.: 13/369,292

(22) Filed: Feb. 8, 2012

Related U.S. Application Data
(63) Continuation-in-part of application No. 12/156,813, filed on Jun. 5, 2008, now Pat. No. 8,150,909.

(51) Int. Cl. G06F 17/00

(52) U.S. Cl. 715/273

(57) ABSTRACT

A plaque management server provides document delivery and update services to a digital plaque, such as delivering a document whose status can change. The plaque management server is communicatively coupled to the Internet and accessible over the Internet 113. The plaque management server updates the document currently displayed on the digital plaque device. The plaque management server facilitates the replacement of the document currently displayed on the digital plaque device. It also provides a document status to the plaque when requested, or based on a schedule of reporting updates. The plaque management server interacts with the digital plaque device and provides updates to displayed documents, purchase of copies of displayed documents, access to information related to displayed documents, searches for infringement, helps management of the document that is displayed, etc.

### CROSS REFERENCES TO RELATED APPLICATIONS

The present patent application is a continuation-in-part (CIP) of, claims priority to, and makes reference to U.S. non-provisional patent application Ser. No. 12/156,813, entitled “Digital plaque for displaying certificates, associated documents and current status”, filed on Jun. 5, 2008, docket number 23051US01. The complete subject matter of the above-referenced U.S. Patent Application is hereby incorporated herein by reference, in its entirety.

### BACKGROUND

1. Technical Field

The present invention relates generally to a plaque that is used by a user to display a document or certificate, and particularly to a solution wherein a digital plaque makes it possible to display one of a collection of documents, transcripts, licenses, achievement awards, etc.

2. Related Art

Plaques are often used for employee recognition. Plaques can be ordered on the Internet and a user can select a type of frame—word, metal, plastic, etc. The user can upload a customized artwork and photos and they get engraved on the plaques ordered. Quite often, an employee hangs several plaques on the walls of his workspace. In addition, some users display the plaques on their desk at work. Quite often employees run out of space and cannot display new ones on the walls or the desks. Plaques are provided to employees of a company to commemorate an event, to appreciate work done, etc. Plaques are provided when patents are issued, and for graduation too. Quite often employees run out of space to display the plaques provided to them.

Users sometimes have information engraved on a plaque that later on becomes outdated. Users have no way to modify the plaques and they have to order new ones at considerable expense. Outdated plaques are usually discarded and new ones ordered. Often users need to duplicate or copy the information available on a plaque. They often use a photocopier to make a copy, which usually does not look clean or clear when photocopied.

A typical dentists office displays over 20 plaques of various kinds in the waiting room, some of them displaying a license to operate, other displaying educational certificates, some displaying testimonials, etc. Often, rearranging these plaques, especially when new ones have to be added, is a headache. Just shuffling the order of display is a chore. Even changing the order in which plaques are arranged is a chore. When an update to a document displayed is received, replacing the old one with a new one is a headache requiring over 30 minutes of work.

Users typically forget when their license to operate a business expires. The plaques fail to remind them of these expiry dates. Inventors who frame their patents also often forget to pay the maintenance fees due, and end up having their patents abandoned. They also forget when their patents expire, etc.

Students get transcripts from their schools/colleges and they would want to frame them and put them up on a wall. When they get a more recent/updated transcript, they often take it down, replace the old document with the new one, and nail them back on a wall. This process is laborious and not easy for the elderly. Professionals such as doctors and engineers acquire a license to operate, and they often put them up on a wall as a plaque. However, when these licenses are renewed, they need to get new plaques made, at considerable expense of money and time, to put them up on a wall in their offices. Again, this activity is time consuming and expensive.

Some writers who get a book published often get a plaque made of their book cover and display the plaque. When a new version/edition of the book is subsequently released, the old plaque becomes obsolete and the writers get new plaques made to replace older ones, at some expense of time and money. This is inconvenient and there is a need to display updated/recent editions for book covers in more convenient methods.

Often people make a poster or a plaque that also comprises a photo of one or more individuals, such as a school graduation photo of a high school student. Years later, that student will have forgotten who his friends are in that photo, and will have lost touch with them. There is no easy way today to determine who those various friends are and what they are currently doing, or where they live, without going through considerable time and expense to determine that information.

Sometimes inventors apply for a patent and get a plaque made when they get a patent granted (or when they apply for it), and put the plaque on a wall in their office. The patents need maintenance fees to be paid periodically, and the inventors have no easy way to determine when these fees are due, and some of these patents get abandoned. Thus, there is a need to determine/display the various status of a patent or a patent application so that an inventor can act upon it, and there is no easy way today to do that currently, even though an inventor can put up a plaque that might remind him of the need to check the status once in a while by calling into the patent office (such as USPTO) or searching online.

Quite often people frame a old photo that shows faces of multiple individuals. Years later, a user might want to determine what those individuals in the photo are currently doing, or even try to remember their names or their relationships to his own life. If the user has very little recollection of his friends, then there is no easy way for him to determine their names, their current profiles or their whereabouts. Thus the user has no way to get in touch with those individuals.

In most companies, rewarding hard working employees is a great way to keep them motivated and feeling valued in the workplace. Companies provide numerous products perfectly geared towards accomplishing this mission, including personalized corporate awards and gifts, wooden, acrylic, and crystal plaques, star trophies and paperweights, desk name plates, globe awards, clocks, wine box sets, and barbeque sets. These are great gifts to give employees, such as to reward individuals who have met personal or corporate set goals, or to recognize certain workers whose accomplishments stand out among the other workers. Personalization makes them a greatly appreciated gift that any employee will treasure forever. However, information engraved, printed or otherwise displayed on traditional gifts cannot be updated, changed, revised. This is sometimes a problem.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block diagram of an exemplary plaque management server that is communicatively coupled to a digital plaque that it interacts with and manages selectively.

FIG. 2 is a flow chart for an exemplary operation of the plaque management server of FIG. 1.

FIG. 3 is a schematic block diagram illustrating an exemplary network in which a plaque displays a document that can change status.

FIG. 4 is a perspective block diagram of a first interface in a server, such as in the plaque management server of FIG. 1, that provides access to various external servers and documents and services provided by external systems.

FIG. 5 is a flow chart of an exemplary operation of the digital plaque device as it displays a digital photo/image, wherein the digital photo/image is selected for display by the user.

FIG. 6 is a flow chart of an exemplary operation of the digital plaque device as it displays a patent, patent application or trademark.

FIG. 7 is a flow chart of an exemplary operation of the digital plaque device as it displays a license to provide a service or license to operate a business.

FIG. 8 is a flow chart of an exemplary operation of the digital plaque device as it interacts with other digital plaques in proximity and manages what is displayed on them.

FIG. 9 is a flow chart of an exemplary operation of the digital plaque device as it displays a graduation diploma, graduation award or transcript selected by a user.

FIG. 10 is a perspective block diagram of a system comprising a plaque that is capable of not only interacting with a plaque management server, but also capable of managing a plurality of other digital plaques in proximity, wherein each of the plurality of digital plaques can be assigned documents to display, updates to display, schedules to update its displayed documents and server to interact with.

FIG. 11 is a perspective block diagram of a system comprising an electronic device with digital plaque support that is capable of not only displaying updateable documents, interacting with a plaque management server, but also interacting with a second digital plaque.

FIG. 12 is a flow chart of an exemplary operation of the digital plaque as it displays a document, wherein the document is a digital photo/image and wherein the digital plaque is capable of identifying an individual shown in the digital photo/image and retrieving a recent photo/image of that individual in addition to professional and personal profiles of that individual.

FIG. 13 is a flow chart of an exemplary operation of the server, such as a picture server or a plaque management server, wherein the server is capable of processing a portion of the displayed digital photo/image, or a whole digital photo/image in order to identify the selected individual(s) and retrieve newer/more recent digital photos and profiles for these selected individuals.

FIG. 14 is a flow chart of an exemplary operation of the digital plaque device, when it displays a patent award (such as a patent granted by the USPTO), as the digital plaque retrieves updated documents, infringement information, etc.

FIG. 15 is a flow chart of an exemplary operation of the digital plaque device as it retrieves patent infringement information employing a technique that generates a list of significant words that is the used to retrieve product information, and product news that hint at potential infringement.

### DETAILED DESCRIPTION OF THE DRAWINGS

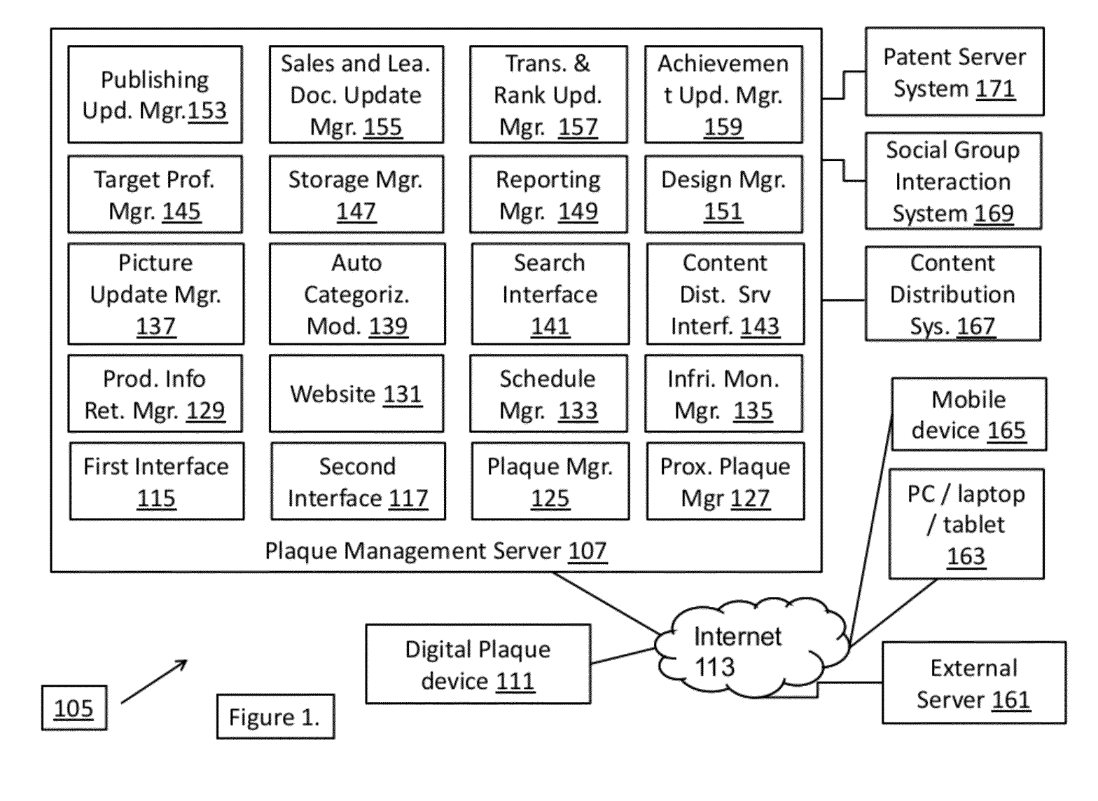

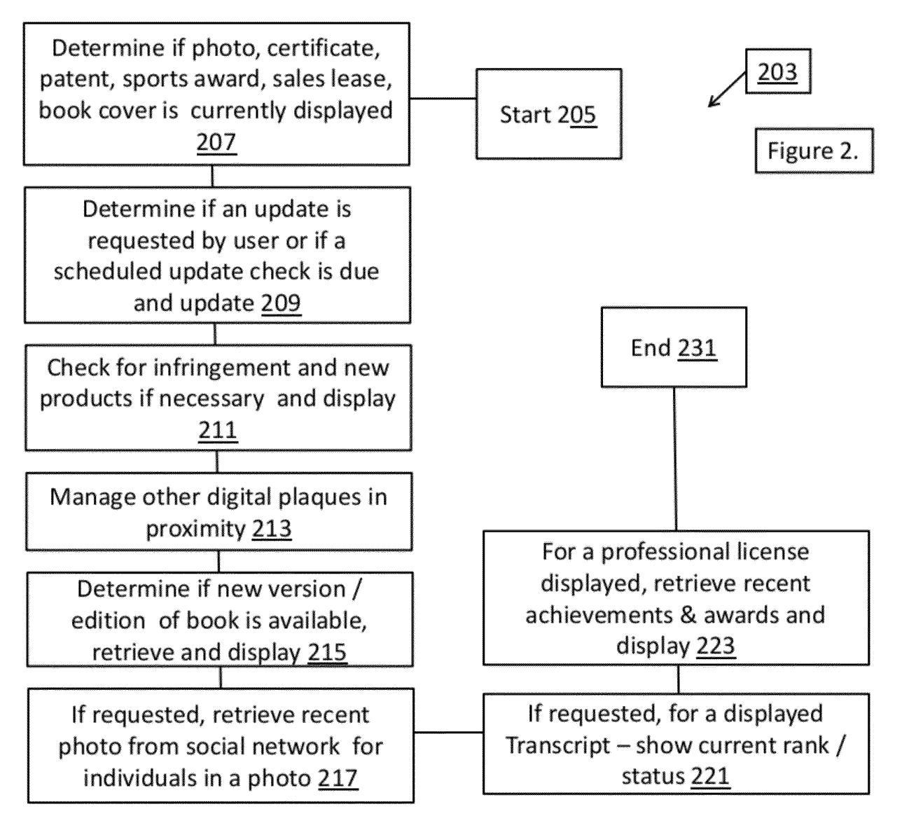

FIG. 1 is a schematic block diagram of an exemplary plaque management server 107 that is communicatively coupled to a digital plaque 111 that it interacts with and manages selectively. The plaque management server 107 provides document delivery and update services to the digital plaque 111, such as delivering a document whose status can change. The plaque management server 107 is communicatively coupled to the Internet 113 and accessible over the Internet 113. The plaque management server 107 comprises a communication interface for interactions with a digital plaque device 111, and a first interface 115 to interact with an external system or external server 161 to request document updates and receive update information in return. The plaque management server 107 facilitates retrieval of content employing the first interface 115 for display on the digital plaque device 111 wherein the content is a document comprising a digital image, a video, an audio, a textual item, or a combination of these. The plaque management server 107 updates the document currently displayed on the digital plaque device 111. The plaque management server 107 facilitates the replacement of the document currently displayed on the digital plaque device 111. The plaque management server 107 provides a document status to the plaque when requested, or based on a schedule of reporting updates. The plaque management server 107 retrieves another document for display on the digital plaque device 111 based on user selection of an item presented in the document or user selection of a region of the displayed document. The plaque management server 107 selectively schedules, based on a document type for example, automatic retrieval of status and updates for the document that is displayed on the digital plaque device 111.

The plaque management server 107 comprises a first interface 115 that it uses to interact with external servers and systems to retrieve/receives documents for display and updates to documents, etc., and a second interface 117 to interact with other digital devices in proximity, local content servers and document management systems, etc.

The first interface 115 comprises one or more of a social network server interface, a picture server interface, a video server interface, a patents system interface, a web crawler interface and a publisher's server interface. It also comprises a content server interface, a registration interface. The social network server interface of the first interface 115 facilitates interaction with one or more social networks to retrieve a more recent digital photo of a user, to selectively retrieve a user profile based on one or more parameters, to create a new social interaction group in an automated mode, and to send messages to one or more people, a picture server interface that facilitates retrieval of one or more recent pictures of a user based upon one or more parameters. The video server interface of the first interface 115 facilitates retrieval and or streaming of one or more videos;

The patents system interface of the first interface 115 makes it possible to retrieve patents, retrieve status of a patent, retrieve a list of patents filed by a user, retrieve a list of patents filed by other co-inventors listed on a given patents, and assemble or compute potential infringement data. The web crawler interface of the first interface 115 facilitates communicating a request to a web crawler and receiving in return a collection of relevant data that is collected by an external web crawler. The publisher's server interface of the first interface 115 facilitates purchase of books, retrieval of a new book cover if available for a given book, reviews for a book, book sales information, citations of a book and other publishing related information. The content server interface of the first interface 115 in the plaque management server 107 facilitates retrieval of necessary content related to a currently displayed document. The registration interface of the first interface 115 verifies registration information for one or more users, facilitates registration of new plaques and their users, and facilitates management of a group of plaques.

The plaque management server 107 facilitates updating a patent award or patent application displayed on the digital plaque device 111. For example, when the document that plaque management server 107 helps display on the digital plaque device 111 is a patent award or patent application, the plaque management server 107 facilitates updating the patent award/patent application by retrieving a status for the document (patent data displayed), the status comprising one or more of an expiry date, maintenance fees due date, assignment changes, information on continuations, potential infringement information, products that embody the patent and publications that refer to the patent. For example, it retrieves a patent application status comprising, fees due, expiry date on an office action, etc. from a patent server system 171 (such as the USPTO managed patent application website/servers) for a patent application currently displayed on the digital plaque device 111.

The plaque management server 107 facilitates updating a digital image/digital photo displayed and retrieving information on one or more individuals who are in the displayed digital image/digital photo. For example, when the document displayed on the digital plaque device 111 is an old digital photo comprising one or more individuals, the plaque management server 107 receives a user selection of a region on the old digital photo from the digital plaque device 111 (alternatively a user provided tag assuming the user has tagged the individuals in the displayed digital photo/digital image), wherein the user selection comprises selection by the user of one of the one or more individuals in the old digital photo. The plaque management server 107 then retrieves another document that is a more recent digital image comprising the one of the one or more individuals. It then replaces the old digital photo with the more recent digital image (or displayed the more recent digital image and user profile, etc. in a pop-up window or a second window). The plaque management server 107 also retrieves a more recent digital image from a social interaction network employing the social network server interface that is part of the first interface 115.

When the document displayed on the digital plaque device 111 is a license certificate, the plaque management server 107 receives a user selection from the digital plaque device 111 that comprises a request to retrieve and communicate associated achievements awards, accreditation details, and relicensing information, and wherein the plaque management server 107 retrieves the requested information and communicates them to the digital plaque device 111.

The plaque management server 107 is also communicatively coupled to an electronic device with plaque display support, such as a mobile device 165, a pc/laptop/tablet 163, or a second digital plaque device, wherein these electronic devices are capable of displaying a document, displaying a status of the document, updating the document, replacing the document, retrieving information related to the document and purchasing one or more original copies of the document. The plaque management server 107 employs the second interface 117 in one embodiment to interact with the electronic device that is capable of plaque display support.

In one embodiment, the plaque management server 107 is communicatively coupled to a digital plaque 111 by a 802.11 based (a/b/n/g protocols) communication network 113, and the plaque management server 107 that manages the digital plaque 111 while also delivering requested documents, updates to documents such as status information, and related other documents (based on a document type, for example, associated with the currently displayed document). In a related embodiment, the plaque management server 107 is communicatively coupled to a digital plaque 111 over a near field communication (NFC) or bluetooth communication link.

In one embodiment, the digital plaque 111 also gets alert messages from nearby devices, such as a digital timer set to count down a set cooking time, or an alert message received from a door bell or a gate bell, that also provides a snapshot of a person at the door/gate. Thus, the digital plaque device 111 can also be used as a generic display device to display alert messages from other devices in vicinity, while also essentially being able to display documents such as transcripts, patents, awards, photos that have updated status that need to be retrieved/received and displayed. In particular, the interactions using a local communication network/links can be over Bluetooth, NFC, IR, cellular links, WiFi links and other local area network protocols. The plaque management server 107 supports communicating the alert messages to the mobile device 165, the PC/laptop/tablet 163, and with other devices, over the Internet 113 or over local communications (WiFi, near field communication (NFC), bluetooth communication link, etc.) means employing the second interface 117.

In one embodiment, the plaque management server 107 comprises a publishing manager interface 153 to interact with external publishing system and retrieve updates to book covers displayed on the digital plaque device 111, information of new versions/editions of those associated books, sales figures, addendums, digital copies of at least one portion of the associated books, etc. It also comprises a sales and leasing document update manager 155 that facilitates display of sales deed documents and leasing documents, retrieval of updates to these sales deed documents and leasing documents and the subsequent storage and display of the retrieved updates on the digital plaque device 111, etc. The transcripts and rank update manager 157 facilitates display of transcripts, graduation awards, certificates, etc., retrieval of updates (such as a change in a rank, or a computed updated rank, etc.) for the transcripts, graduation awards, certificates, certificates of achievement, and display of the retrieved updates on the digital plaque device 111 in the same window, a pop-up window or in an additional window.

The plaque management server 107 also comprises an achievement update manager 159 that makes it possible to determine recent achievements, awards, publications, license, citations, etc. for a user associated with a currently displayed license (such as a medical doctor's license to operate in a state, a teacher's teaching license and certificate, or a attorney's juris doctorate (JD) certificate that identifies the bar/state where the attorney can provide services, etc.) to operate/provide services on the digital plaque device 111. It also comprises a picture update manager 137 that updates a currently displayed digital photo, optionally replacing it with a newer/better version that may be available on an external server (or a database/website to which access is available) or in the plaque management server 107. In addition, it comprises a auto categorization module 139, a search interface 141, a content distribution server interface 143, a target profile manager 145, a storage manager 147, a reporting manager 149, a design manager 151, a product information retrieval manager 129, a website 131, a schedule manager 133, an infringement monitoring manager 135, a plaque manager 125, and a proximity plaque manager 127.

The auto categorization module 139 facilitates categorization of a new type of document that is displayed. For example, if the user searches, retrieves and selects a new document for display on the digital plaque device 111, and the document is of a type not seen before by the plaque management server 107, or the digital plaque device 111, the auto categorization module 139 determines a type for the document being displayed, and assigns an update schedule and update policy to it.

The search interface 141 facilitates searching for documents by a user using the digital plaque device 111. It also facilitates searches for documents by a user using the website 131, wherein the selected document can then be assigned for display on the digital plaque device 111 by the user using the website 131. The search interface 141 also facilitates searches by a user from the digital plaque device 111. It employs external servers to retrieve the required information/documents, as needed.

The content distribution server interface 143 makes it possible to retrieve content stored in external severs, such as by employing document ids, URLs/links for documents, a title, references for documents, publication information, author/writer information, etc.

The target profile manager 145 makes it possible to retrieve profile of users of the digital plaque device 111, profile of individuals who are referenced in documents such as patents, patent applications, licenses, certificates, etc. It also stores and manages profiles of individuals who appear in photos/images displayed on the digital plaque device 111. It maintains links/references to profiles of users (such as references to profiles at social networks where such users have a profile maintained and perhaps even a website/blog maintained) and individuals associated with documents displayed on the digital plaque device 111. It retrieves the profile from external servers, such as a social group interaction system 169 (such as Facebook, Google+, etc.), and stores them locally, if necessary (as instructed by a user).

The storage manager 147 facilitates storage and retrieval of user profiles, documents displayed, updates to documents, schedules of updates, monitoring data collected that is subsequently reported to a user on the digital plaque device 111, search strings created by a user, etc. The reporting manager 149 runs automated reports comprising infringement for patents, new patents filed by specific inventors, new products released in the market that might be of interest to a user or that are potentially related to a displayed document (such as a patent, patent application, trademark, a publication, etc.). The reporting manager 149 also creates reports as per a schedule set (by user or by the plaque management server 107). It facilitates creation of reports on recent updates to documents of interest to a user, updates (professional and personal information updates) to individuals whose face is shown in a digital photo currently under display on the digital plaque device 111, etc.

The design manager 151 facilitates designing how a document is to be displayed, and also facilitates changes to the way a document is displayed. It stores information on how a document is to be displayed, how status updates need to be presented, the format for displaying different types of documents (such as the size of window, the borders, the margins, the sub-windows or pop-up windows for updates to be displayed), the optional music and/or video to be played while a document is displayed, etc.

The product information retrieval manager 129 facilitates searching and retrieval of information on products of interest to a user, such as a product that might be potentially infringing on a given patent or trademark displayed by a user on the digital plaque device 111. It also retrieves various products that might be based on, or associated with a given patent, patent application, or trademark. It also retrieves advertisements and marketing material associated with a given product or company/organization. In addition, it retrieves one or more products of a user specified category/type.

The website 131 makes it possible of a user to manage one or more digital plaque devices 111, assign documents for display to the one or more digital plaque devices 111, setup update schedules for the documents displayed, search for documents to be displayed, design windows/frames for the display of specific types of documents, select from available themes for document types supported, etc.

The schedule manager 133 facilitates creation of schedules for automatic updates to displayed documents, schedule for retrieving associated documents, schedules for searching for products and services of interest (that might be associated with currently displayed document), schedules for searching for infringement information for currently displayed patents and trademarks, schedules for updates to ranks associated with transcripts and scores, etc.

The infringement monitoring manager 135 makes it possible to automatically monitor potential infringement on displayed patents/trademarks, copyrights on documents, other related property, etc.

The plaque manager 125 facilitates managing one or more digital plaque devices 111 that are communicatively coupled to the plaque management server 107. It also facilitates updating firmware/software in the digital plaque devices 111, updating subscriptions to services (subscribed to by a user/owner of the digital plaque devices 111) and managing access from remote devices/computers/servers. It facilitates secure access, management of passwords, usernames, digital certificates, etc., as necessary for security and authentication during interactions with the plaque management server 107, pc/laptop/tablet 163, mobile device 165 and external servers 161.

The plaque management server also supports subscribing to a service (by means of a monthly subscription, for example) wherein the user, on initial purchase of the digital plaque device 111 has access to a default level of service that enables the user to configure and operate the digital plaque device 111, including assigning one or more documents for display and setting up a schedule of updates/checking for updates, etc.

The proximity plaque manager 127 keeps track of one or more other/additional digital plaque devices in proximity to, and communicatively coupled to, the digital plaque device 111. It keeps track of currently displayed documents on these one or more other/additional digital plaque devices, and it provides updates to these displayed documents while also processing user selections, user requests and user inputs from these one or more other/additional digital plaque devices.

The present invention makes it possible to display a photo on the plaque and then be able to update it or replace it with a more recent picture retrieved and displayed for individuals in the old photo.

The present invention is based on the idea that any document displayed needs to be updated subsequently, at least with status information and with information of imminent changes to its status. For example, an old picture can be displayed on a touch sensitive screen of a digital plaque device 111 (or one with user interface elements/prompts) and a user can select one of the individuals in the photo (touching a face for example), and the digital plaque device 111 would contact the plaque management server (or an external server directly, such as a Facebook server directly) and retrieve a more recent picture for that individual in the displayed photo. This is facilitated in one or several ways, depending on the plaque management server capability. In one embodiment, a plaque client in the digital plaque device 111 identifies characteristics for a user selected face in a displayed digital photo/image, communicates it to the plaque management server 107, which would then search through its own database or use an external server 161, or an external social group system 169, such as Google's server or Facebook server in order to retrieve a target person who fits those facial characteristics, as modified by age (optionally specified by a user). Then, for example, the latest Facebook picture for that person is retrieved (or from Skype or Google+) and shown on the digital plaque device 111 in a pop-up window or an additional scrollable sub-window, etc.

The digital plaque device 111 receives a more recent digital image that is retrieved from one of a social interaction network 169 accessible over the Internet, a picture server accessible over the Internet via a picture server interface, a database and a network storage device.

The present invention makes it possible to automatically detect potential infringement for displayed patents. Other features supported include detecting and showing potential infringements, retrieving and displaying maintenance fee deadlines, identifying similar patents filed if any, and sales of similar patents by other inventors. It also supports identifying a latest list of other patents filed by the same user/inventor that is retrieved and displayed. Features supported by the present invention also include retrieving and displaying a list of patents filed by or owned by other co-inventors of a given patent and a list of products that “embody” an invention is associated with a given patent that is displayed.

In one embodiment, based on patent abstracts and independent claims of a currently displayed patent, a list of significant words is created (by the digital plaque device 111, for example, or alternatively by the plaque management server 107), also factoring in the group and art categories for that patent/patent application. Next, for all the user's digital plaque devices, their currently displayed patent/trademark is retrieved (periodically) by the plaque management server 107. This plaque management server 107 then, only once (for the first time) in some embodiments, generates the list of significant words and then saves it (either in plaque management server 107 or at an associated digital plaque device 111). It then tries to match the list of significant words, periodically for example, for all users of the digital plaque devices (registered users, who may have to pay a subscription too) against tradeshow reports, trade magazines, conference papers, exhibitions, etc. and looks for “potential infringements”.

In general, the comparing of the “the list of significant words” to tradeshow reports, trade magazine articles, conference papers, etc. first involves reordering or re-weighting the list of significant words for that specific technology. For example, if the trade magazine or conference is about Wifi, then a word “framing” might be of more importance than the word “display” or the phrase “frames per second”, which would not be the case if the trade magazine was an iPhone related magazine/conference/document. Thus reordering a list of significant words for a patent, or re-weighting of the list of significant words, per each reference document/publication based on the field of science, engineering or technology is one of the unique features of the present invention.

In general, the plaque management server 107 is mostly responsible for generating “potential infringement” reports while the digital plaque device 111 displays it when it receives such a report, although in some embodiments the digital plaque device 111 itself determines potential infringements. The user in the digital plaque device 111 can initiate such generation of a report if necessary. Also, the digital plaque device 111 client (employed by the digital plaque device 111 to execute the necessary operations, in accordance with the present invention) can generate the “list of significant words' and let the user tailor it if necessary (optionally).

The digital plaque device 111 facilitates user selection of a book/book cover on the digital plaque device 111, such that the digital plaque device 111 subsequently displays a book cover on the digital plaque device 111. The latest version of a book is then automatically retrieved (or when triggered by the user) displayed, such as a edition 2 book cover of a book whose edition 1 is currently being displayed on the digital plaque device 111, if the edition 2, a more recent edition, is currently available. The user can update the book cover displayed on the digital plaque device 111, and have the more recent book cover (for more recent version/edition) replace the older book cover, or have both of them displayed, etc. For example, a plaque client in the digital plaque device 111 interacts with a publisher's server, searches for newer versions, retrieves details and presents it. Alternately, the plaque management server 107 receives a request from a digital plaque device 111 periodically to look for an updated version of the book cover being available, and retrieve that (such as from Amazon or Barnes & Noble or publisher for example) and send it to the plaque client for display in alternate window or as replacement (user preference) to the older edition cover. In addition, the user can place orders for one or more copies of a book whose book cover is currently displayed, and the user is prompted to make appropriate payments for such online purchase orders.

When a user employs the digital plaque device 111 to select/load/copy/retrieve a sales deed/lease document, it is then displayed and a default update schedule is setup. If there is an update to ownership of a property associated with the sales deed/lease document, then that ownership change is shown by the sales deed/lease document. Lease expiry details are also displayed if necessary for leases that are selected by a user for display on the digital plaque device 111. For example, if the lease is for condo, then when the condo management changes, or the owners of the building where the condo is located changes hand, or the property management changes, it can be shown in a lease document displayed on the digital plaque device 111, or on a sales deed for the condo, or some ownership document for that condo that is displayed on the digital plaque device 111. Similarly, for a leased car, or a leased property, if the ownership changes (in the background without this lease holder's knowledge), then updates to ownership and other status information (such as lease expiry coming up) is displayed by the digital plaque device 111.

A digital plaque device 111 built in accordance with the present invention displays transcripts selected by a user. The updates to the transcript shows how the user's ranking has changed, and how it stacks up to more recent tests. Although the raw data and scores of a SAT test, GRE test, etc. may be static, and shown in a transcript or certificate, the relative ranking may change over time. For example, a SAT score of 2300 out of 2400 may have been 85 percentile when a user took the test, but in the current year, it would have been something else, perhaps 90 percentile. Thus the digital plaque device 111 shows a SAT/GRE transcript, while every year updating its relative ranking, in light of more recent tests.

When the document displayed is a sports achievement certificate, changes to rankings in light of more recent sports events/matches, are displayed on the digital plaque device 111. Therefore, for an athletic achievement certificate displayed, one where the certificate specifies a rank an updated ranking that is available is retrieved (or computed) for display. For example, for a race where a runner was ranked 1st in 100 m race, with 90 seconds time, and based on more recent races, an updated ranking can be computed/retrieved for display, so as to specify an all time ranking, such as be 10th in all time ranking, the digital plaque device 111 supports display of such updates.

The present invention supports interaction between a plurality of digital plaque devices located in communication proximity to each other. One of plurality of digital plaque devices in a premises acts as a manager and manages display on others, updating them as necessary, sharing whatever document is displayed on its screen with others of the plurality of digital plaque devices, assigning what needs to be displayed in various of the plurality of digital plaque devices nearby, providing a means to search, select and assign for display various patents, certificates, photos, videos, etc. on individual ones of the plurality of digital plaque devices in proximity. In general, the management software that is part of a plaque client on a digital plaque device makes it possible to make and manage a schedule of what document is displayed on what plaque and for how long.

The present invention supports display of a professional's license (such as a dentist, doctor's medical license, plumbers license, a mechanic's license, etc.) on the digital plaque device 111 which can be enhanced by an automated update with additional displays of more recent achievements, recent publications, etc. It also supports display of a “license to operate a business” along with all the various permits obtained to run the business. For example, these permits that are displayed along with the license to operate a business typically include zoning and land use permits, especially for new manufacturing businesses and certain home-based business operations, health department permits, especially business involving the preparation and/or sale of food, sales tax license for the selling of almost all products and services, fire department permits, especially for businesses that attract large numbers of customers, and special state-issued business license or permits, for businesses that involve the sale of the products such as firearms, liquor, lottery tickets, and gasoline.

The present invention also supports displaying licenses for professionals who provide professional services. For example, it facilitates display of special state-issued occupational/professional licenses, for individuals who offer a number of state-regulated services, including: Medical care, Auto repair, Real estate sales, Tax services, Insurance sales, Cosmetology and Legal representation (attorneys). The present invention also contemplates the need to display on the digital plaque device 111 special federal business license or permits, such as those typically used for Investment advising (Securities & Exchange Commission), Drug manufacturing (U.S. Food and Drug Administration), Preparation of meat products (U.S. Food and Drug Administration), Broadcasting (Federal Communications Commission), Ground transportation, i.e. trucking (U.S. Department of Transportation), Manufacturing tobacco, alcohol, or firearms; or selling firearms (U.S. Bureau of Alcohol, Tobacco, and Firearms).

The digital plaque device 111 built in accordance with the present invention provides a design tool in the digital plaque device 111 (or alternatively using the design manager 151) that helps a user create a new design (new look and feel, for example) for the display of a document/digital certificate on his digital plaque device 111. The new design is then used to display his current/existing certificate or achievement award, or a sports award plaque, an achievement award plaque. The design tool also facilitates design of certificates/awards/documents to be given to a friend, colleague, etc. The user can then, via the design manager 151 in the plaque management server 107, place orders for creation of a personalized digital plaque based on that design. In one embodiment, the user's design of a customized digital plaque is forwarded to a professional service by the plaque management server 107, wherein the professional service, accessible via Internet 113, subsequently creates a customized digital plaque and ships it to the user or to another recipient. The professional service also provides copies of certificates/awards designed by the user on the digital plaque device 111, and ships them to an address provided (and payment arrangements are made/provided). Thus the digital plaque device 111 facilitates design of certificates/awards that can be subsequently printed/shipped and also the design of new digital plaque devices that can be manufactured, customized and delivered.

The plaque management server 107 interacts with the digital plaque device 111 and provides updates to displayed documents, purchase of copies of displayed documents, access to information related to displayed documents, searches for infringement, helps management of the document that is displayed, etc.

In one embodiment, based on a set of pictures obtained for various people who are registered members of the plaque management server 107 (wherein the set is about 50 pictures, for example, using tagged images available in a picture server or in a social interaction group system 169) one or more potential targets/users are identified, and the user of the digital plaque device 111 can select the right one from a list of the one or more potential targets/users, as an updated image (to a currently displayed photo/image) of a person from his older photo displayed on the digital plaque device 111.

In one embodiment, the plaque management server 107 is capable of face recognition based on a user selected region of a digital photo/image displayed, employing facial characteristics determination tools, and a set of reference photos available, such as at a picture server communicatively coupled to the plaque management server 107. A user would highlight or point to a small region, sometimes referred to as face location information, (typically around a face of an individual shown in a digital photo/image). Thus, the plaque management server 107 determines whether one or more items of face location information are available. In general, face location information can be used to identify the location of a face within a captured image. In some implementations, the plaque management server 107 provides a face detection module to automate the process of face location. In some embodiments, the digital plaque device 111 comprises face detection module to determine face location information. Thus face location information can be generated by a face detection application or module, either in the digital plaque device or in the plaque management server 107, or both. For example, face location information can be provided by the OKAO Vision face detection technology based face detection module available in the plaque management server 107. In some other implementations, face location information can be supplied by a user of the digital plaque device 111, who can be prompted to provide input identifying the location of a face in one or more displayed digital photos/images. For example, a user can provide input to a touch sensitive screen identifying a facial boundary or a facial feature in a currently displayed digital photo/image on the digital plaque device 111. In one related embodiment, the digital plaque device 111 facilitates capture of a digital photo of a user and the retrieval of a user profile (professional as well as personal, if any) and recent photos, patents, publications, references to blogs, etc. for the user whose digital photo is captured. The captured digital photo and retrieved information is then displayed as the new interactive document to be displayed on the plaque.

In one embodiment, one or more registration points are determined in the currently displayed image on the digital plaque device 111, that has been captured using a digital camera associated with (or part of) the digital plaque device 111. The one or more registration points are selected to facilitate the alignment of the captured image with one or more additional images, such as a reference image. In some implementations, four registration points corresponding to the corners of the eyes the corners of the mouth of an individual in the captured image is selected. In some other implementations, more, fewer, and/or different registration points are selected. The registration points in the captured image is determined automatically or manually. For instance, one or more registration points can be automatically determined in accordance with face location information generated by a OKAO Vision face detection technology based module available in the digital plaque device 111. The face location information can include data indicating points in a detected face, such as the corners of eyes, a nose, and the corners of a mouth. Further, the captured image can be presented to a user, who can manually provide input identifying one or more registration points. For example, the user can indicate the location of one or more registration points through a cursor or touch screen interface on the digital plaque device 111. The registration points are stored in the digital plaque device 111, and optionally in the plaque management server 107, associating it with the captured image currently displayed on the digital plaque device 111.

In one embodiment, a client module in the digital plaque device 111 identifies patent or trademark for updates or for patent infringement reports. Based on patent abstracts and independent claims, or trademark category and usage details, a list of significant words is created, also factoring in the group and art categories for that patent or trademark. The server can also generate the list of significant words, if necessary and store it. Next, for all the user's plaques, their currently displayed patent/trademark related information is retrieved (periodically) by plaque management server 107, which then tries to match the list of significant words against significant words in journal articles, trade magazine articles, publications of various kinds, online product information, etc. Thus, for all users of the plaques (registered users, who may have to pay a subscription too for this infringement detection service) the plaque management server 107 compares appropriate significant words (optionally after reordering those words, if necessary) to those associated with journal articles, trade magazine articles, publications of various kinds, online product information, tradeshow reports, trade magazines, conference papers, exhibitions, etc. and looks for “potential infringements”.

For example, comparing the list of significant words to tradeshow reports, trade magazine articles, conference papers, etc. would first involve reordering or re-weighting the list of significant words for that specific technology. For example, if the trade magazine or conference is about Wifi, then a word “framing” might be of more importance than the word “display” or phrase “frames per second”, which would not be the case if the trade magazine was an iPhone related magazine/conference/document. Thus, the plaque management server 107 is mostly responsible for generating “potential infringement” reports in some embodiments.

FIG. 2 is a flow chart for an exemplary operation of the plaque management server 107 of FIG. 1. The operation starts at a start block 205 when the plaque management server 107 determines that a digital plaque device is communicatively coupled to it and is capable of being managed. Then, at a next block 207, the plaque management server 107 determines if the currently displayed document on the digital plaque device is a digital photo, certificate, birth certificates, certificate of achievement, patent, trademark, sports award, sales lease, book cover, license to operate a business, transcript, graduation certificate or some other type of document. Then, at a next block 209, the plaque management server 107 determines if an update is requested by a user or if a scheduled check for an update is due. If it is determined that an update is necessary, then the plaque management server 107 retrieves corresponding update data (from external servers if necessary) and updates the digital plaque device.

At a next block 211, the plaque management server 107 checks for infringement and new product information, if necessary, and displays any potential infringement it detects in new products announced in trade magazines, conferences, journals, news outlets, press releases, company websites, etc. Similarly, it checks for and reports potential trademark infringements and copyright infringements.

At a next block 213, the plaque management server 107 manages other digital plaques in proximity to the digital plaque device it is communicatively coupled to (and managing). It tracks what is being displayed currently in those other digital plaques in proximity, and checks for updates for the associated documents displayed in them. If it determines that updates exist, it send them the updates—for example via the digital plaque device (or alternatively, directly to those individual plaques).

Then, at a next block 215, the plaque management server 107 determines is a new version/edition of a book is available. If it discovers that a new edition of that book (whose book cover is displayed) has been released, the plaque management server 107 presents the new book cover along with other book related details and reviews for display in the digital plaque device (as a replacement document, as an addition to the same window, in an additional window, etc.). This check is conducted when the current document displayed is a book cover, or when the digital plaque device lists a specific book cover as one of the selections made by the user of the digital plaque device (and has registered that book cover for periodic update checks by the plaque management server 107).

At a next block 217, the plaque management server 107 retrieves a more recent photo of a user from one or more social networks (such as Facebook, Google+, LinkedIn, etc.) for display on the digital plaque device. For example if the currently displayed document on the digital plaque device is a digital photo/image, and the user requests an update to that digital photo/image, or if the user selects one of the users (a region around an individual face in that digital photo/image, that may have already been tagged by the user) in that digital photo/image, the plaque management server 107 retrieves an update image for that digital photo/image, or a recent photo of that individual selected, optionally with a user profile (professional and personal profiles) for that individual.

At a next block 221, if requested by a user of the digital plaque device when the displayed document is a transcript, the plaque management server 107 retrieves a current rank and updated status and communicates it to the digital plaque device for display to the user. For example, if the transcript for a standardized test result such as SAT, GRE or TOEFL test result, the associated rank (school rank, state rank, rank in county, national rank, if any) is determined and displayed. In addition, for older test scores, a more recent rank is computed (for example a rank based on average test scores from recently conducted tests, or from more recent versions of those standardized tests) and displayed as an update information. For transcripts such as transcripts for a high school student, a college student, etc. the plaque management server 107 facilitates retrieval of details of the various course work listed in the displayed transcripts, if requested by the user. It also facilitates retrieval and display of course material and additional training material associated with the individual classes/courses listed on those transcripts.

Then, at a next block 223, when a professional license is displayed on the digital plaque device, the plaque management server 107 retrieves recent achievements and awards for that user (individual listed/named in the displayed license) and communicates it to the digital plaque device or display to the user. For example, this retrieval is either user initiated, or based on a schedule of checking for updates.

Then, at an end block 231, the operation terminates.

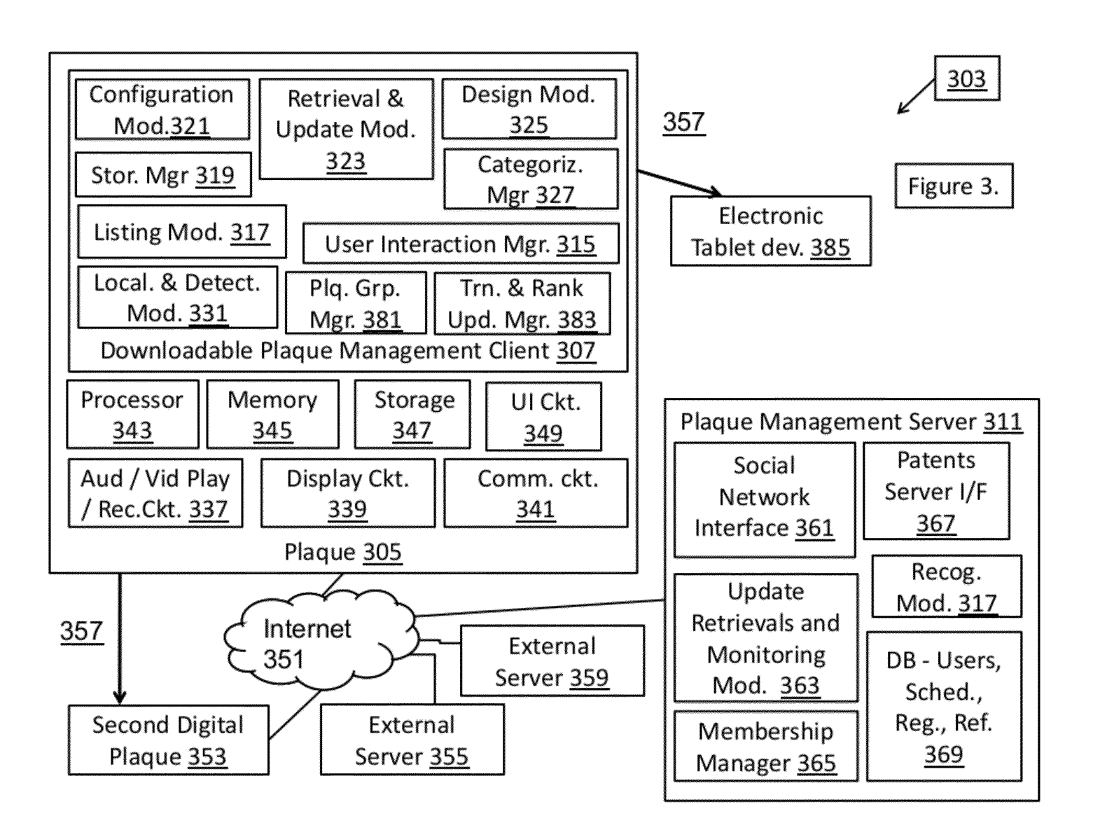

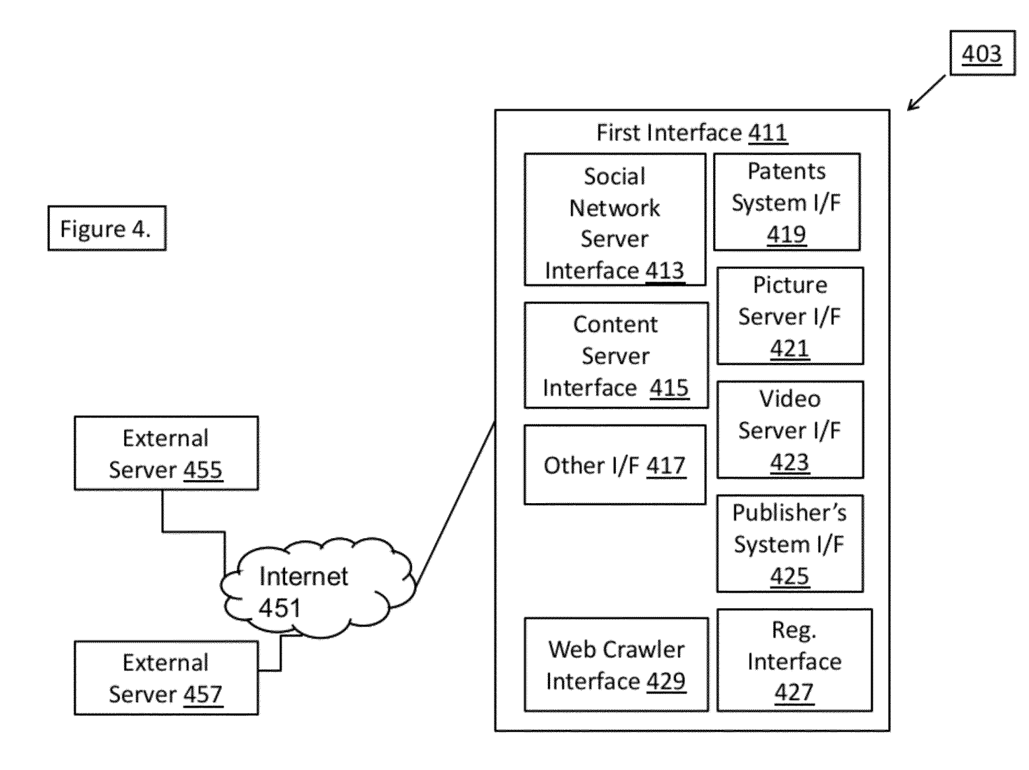

FIG. 3 is a schematic block diagram illustrating an exemplary network 303 in which a plaque 305 displays a document that can change status. The plaque 305 comprises a memory 345, a display circuitry 339, an user interaction circuitry 349, a communication circuitry 341 and a processor 343 that is operably coupled to the memory 345, the display circuitry 339 and the user interaction circuitry 349. The plaque 305 has a screen display that is operated/managed by the display circuitry 339 wherein user inputs (touch sensitive inputs on a touch sensitive screen, data entry from input field presented, button selections, menu item selections, etc.) are received and processed by the user interaction circuitry 349. The user inputs are by means of a remote control unit in some embodiments, wherein communications with the remote control unit is facilitated by the communication circuitry 341 (or a subset thereof).

The plaque 305 also comprises a retrieval and update module 323 that is capable of retrieving content from a server 311, wherein the content is a digital image, a video, an audio, a textual item, or a combination of these. The memory 345 comprises executable code for causing the processor to perform operations such as displaying the document, updating the document employing an update data received or replacing the document employing a replacement document received. The processor also perform operations such as displaying document status as and when they are received and retrieving another document for display based on user selection of an item presented in the currently displayed document or user selection of a region of the currently displayed document. The plaque 305 also presents the another document retrieved selectively along with the currently displayed document in the same window, in a separate pop-up window, or separately in a new window. The plaque 305 selectively schedules, based on a document type associated with a currently displayed document, automatic retrieval of status and updates for that document.

In one embodiment, the document displayed by the plaque 305 is a patent award (such as a patent granted by the USPTO), the status displayed comprises one or more of an expiry date, maintenance fees due date, assignment changes and filing of continuations. In addition, the status information also comprises potential infringement information, products that embody the patent and publications that refer to the patent. For example, all products and services recently announced by one or more manufacturers and service providers, such as in newspapers, trade magazines and company marketing literature are accessed and analyzed by the plaque management server 311 for potential infringement and a report is created that is presented to the user of the plaque 305.

In one embodiment, the document displayed by a user on the display of the plaque (facilitated by the display circuitry 339) is an old digital photo (digital image of a photo taken by a user using a camera, for example, such as those in a jpeg format, tiff format, gif format, png format, bmp format etc.) comprising one or more individuals. The one or more individuals have their face shown in the old digital photo, and the user can select a region of the digital photo along one of those individuals and tag it, if necessary. The user can select such a region around the face of an individual. The user selection of a region comprises selection by the user of one of the (typically one, although it can also be more than one) individuals in the old digital photo, and it is used to get an updated/recent image/photo of that individual to display it on the plaque. Thus, the plaque retrieves another document that is an more recent digital image for that one of the one or more individuals selected by the user on the plaque. In a related embodiment, the plaque 305 communicates the user selection (region of the digital photo displayed) to the plaque management server 311 which facilitates retrieval of the updated/more recent photo of that individual. For example, the plaque uses the user tag (if any) for the user selected region (assuming the user has tagged the individuals in the old digital photo) and communicates the tag to the patent management server 311 (or alternatively, sends it to an external server 355, 359, such as a server associated with a social network such as Facebook, etc.) to retrieve a more recent photo for that individual, along with personal information and profession al information, for display on the plaque 305.

The plaque 305 makes it possible to order copies of transcripts displayed, books covers displayed, patent applications and patent awards displayed, photos displayed, etc.. For example, if a high school graduation transcript is displayed, employing a purchases menu item or button provided, the user can order multiple copies of that high school graduation transcript. The plaque 305 places a purchase order with an external server 355 associated with the corresponding high school (or school district). Similarly, if a SAT, GRE, TOEFL, ACT or other standardized test transcript is currently displayed, the user can order copies of these tests (standardized tests in general) from the educational testing service or other corresponding organization that offers and manages these standardized tests. The plaque 305 communicates user profile or user specific data (including credit card information, if necessary, for example) to an external server 355, 359 and arranges for the purchase of the required number of copies of transcripts, books, photos, etc.

The plaque 305 is capable of retrieving a more recent digital image/photo of a user/individual in a displayed photo from a social interaction network (such as Facebook, Google+, etc.) and from external servers that store photos typically uploaded by users (such as Picasa web, Snapfish, etc.). For example, employing a tag created/associated with an individual's face in a displayed photo, the plaque 305 retrieves an updated/more recent image and displays it. It can also communicate, if necessary, a region/section (user selected region for example) of a displayed digital photo and sends it to the plaque management server 311 where it is processed and used to retrieve (based on characteristics determined from that section) from a local database, external server 355, 359, or a social network (via the social network interface 361) communicatively coupled to the plaque management server 311.

When a license certificate is selected/displayed by a user on the plaque 305, the user can select one or more buttons displayed (or menu items, etc.) that results in sending a request to retrieve and display associated achievements awards, accreditation details, and relicensing information. Thus, a user's request to retrieve and display associated achievements awards, accreditation details, and relicensing information from the plaque 305 results in the retrieval of expiry information, deadlines for relicensing, renewals, payment requirements, training requirements and other licensing related documents and status information.

When the plaque 305 displays a document that is a transcript, the user is shown buttons, links, input fields as necessary to enable/solicit user selection of a transcript, updates to the transcript, retrieval of all related information, access to coursework associated with the transcript, access to course material, access to information about the campus life associated with the education institution, access to memorabilia sold by such a campus, etc. The user can select one or more courses listed on/associated with the transcript. The user selection of one or more courses, for example, is by means of providing or selecting an identification of one of the courses listed in the transcript, in response to which another document is retrieved and displayed that comprises a coursework details, corresponding course materials, and information of additional related courses. It also supports display of a signup form for additional related courses that are relevant to the user (based at least on the transcripts/graduation information/etc.). The user ca use the signup form to register for one or more courses from the digital plaque device 111.

In one embodiment, the plaque 305 displays a document, based on user selections/preferences, wherein the document is a transcript, a certification of achievement, a graduation award certificate that optionally includes a rank data, a document that certifies passing of a test, a document certifying the acquisition of some skills or a diploma. The plaque 305 comprises a transcript and rank update manager 383 that, employing the retrieval and update module 323, updates the document and associated rank data (if any). The transcript and rank update manager 383, employing the retrieval and update module 323, retrieves at least one digital image of an alma mater campus, at least one video of the alma mater campus, an music associated with the alma mater and a description of the alma mater campus life, in response to a user selection that comprises an instruction to play an alma mater information. The plaque then plays the alma mater song, if any, while displaying the at least one digital image and the at least one video. Using appropriate displayed buttons, the user can also retrieve coursework information, training material, refresher material, etc. based on details of the transcript, certificate etc. that is currently displayed. Thus, starting with a document that is displayed, a user can retrieve associated data such as updated ranks, campus information, etc, but also retrieve course work details (such as for specific courses listed on the transcript), course materials, training material, etc. In addition, in a related embodiment, the user can also retrieve souvenirs, tickets, memorabilia and campus related information associated with the transcript or certificate/graduation award displayed.

The transcript and rank update manager 383 displays alma mater memorabilia and tickets to sports events conducted by the alma mater and provides the user an opportunity to purchase them online by placing an order. The user's orders are executed and confirmation of the order are displayed on the plaque 305. For example, the plaque 305 sends the user's order to an external server 355 (such as a server associated with a sales server of a corresponding campus), optionally along with a user profile that also comprises a credit card information and user address, along with user selections of items for purchase.

In one embodiment, the document is a digital photo comprising one or more individuals. The user is provided with an option to select one or more individuals if the digital photo is tagged (with the names of individuals, or with some identification). The user can select one or more individuals in a digital photo displayed and updated information for those individuals, including recent photos, recent professional and personal information are displayed. In a related embodiment, the user selection comprises an instruction to automatically create a social interaction group at a social interaction network, in response to which the plaque interacts with a social group interaction system to automatically setup and configure the social interaction group and communicates a reference to the social interaction group to the one or more individuals.

In one embodiment, the displaying the document on the plaque 305, the updating of the displayed document, the replacement of the document, displaying document status as and when they are received, retrieving another document for display based on user selection/instructions, presenting the another document, and selectively scheduling updates and other activities (related to the currently displayed document) are all conducted or otherwise facilitated by a plaque management server 311 communicatively coupled to the plaque 305, with the plaque 305 providing necessary user inputs to the plaque management server 311 for each of these operations.

In one embodiment, displaying the document by the plaque 305, updating the document, replacement of the document, displaying document status as and when they are received, retrieving another document for display based on user selections, presenting the another document, and selectively scheduling update and document related activities are all conducted, managed or otherwise facilitated by an electronic tablet device 385 communicatively coupled to the plaque 305, with the plaque 305 receiving necessary user inputs from the electronic tablet device 385 (collected by the electronic tablet device 385) for each of these operations.

In one embodiment, the plaque 305 is able to interact with other plaques in proximity, and is even able to manage some of them. A plaque group manager 381 in the downloadable plaque management client 307 of the plaque 305 facilitates interaction with, and management of, a plurality of other plaques 353 in proximity with the plaque 305. The plaque group manager 381, employing the communication circuitry 341 or subsets thereof, interacts with the plurality of other plaques 353, determines their current configuration, and manages what is displayed on each of the a plurality of other plaques 353. In a related embodiment, the plaque group manager 381 shares a currently displayed document with the plurality of other plaques 353 in proximity.

In one embodiment, the plaque 305 displays a photo, one that comprises several individuals. The plaque lets a user select one of the faces in the photo to retrieve a latest photo for that individual, along with a collection of his professional and personal information. The plaque interacts with external servers to retrieve such information and displays it in a pop-up window or a sub-window. In a related embodiment, the plaque 305 contacts the plaque management server 311 to get the latest information about that individual, which then interacts with external servers, such as a server the Facebook service, Google+service, Linked-in service, etc. to retrieve personal and professional information for that individual and present it to the user on the plaque, such as in a pop-up window or sub-window. For example, the retrieved information can be a latest photo, current occupation, current address, etc.

In another embodiment, the plaque 305 enables tagging the various individuals in a photo with information such as their names, IDs, address, etc. Once a photo is tagged by a user, the plaque, either by itself or with the help of the server, automatically tags other photos stored in an album, library or collection (optionally with user permission), with similar tags for individuals identified to be the same individuals in the other photos of the album, library or collection.

In one embodiment, the plaque 305 also gets alert messages from nearby devices (electronic devices in its vicinity, for example), such as a digital timer set to count down a set cooking time, or a alert message received from an electronic door bell or an electronic gate bell, that also provides a snapshot of a person at the door/gate. The communication circuitry 341 facilitates communication with local devices over Bluetooth, IR, NFC, 802.11 based protocols (a/b/g/n/ etc.), and other local network protocols. Thus, the plaque 305 can also be used as a generic display device to display alert messages from other devices in vicinity, while also essentially being able to display documents such as transcripts, patents, awards, photos that have updated status that need to be retrieved/received and displayed. In particular, the interactions using a local communication network/links can be over Bluetooth, NFC, IR, cellular links, WiFi links and other local area network protocols. Thus, while displaying a transcript for a user, the plaque 305 receives an alert message from the electronic door bell with which it is communicatively coupled, that also sends a snapshot (digital image) of a person at the door, and the plaque 305 opens a pop-up window, employing the display circuitry 339, displays the snapshot sent by the electronic door bell and also rings an alert audio message or alert tone, as previously configured, for a user in vicinity to view. The user can dismiss that pop-up window or the plaque 305 automatically removes the pop-up window after a default duration (such as 5 minutes).

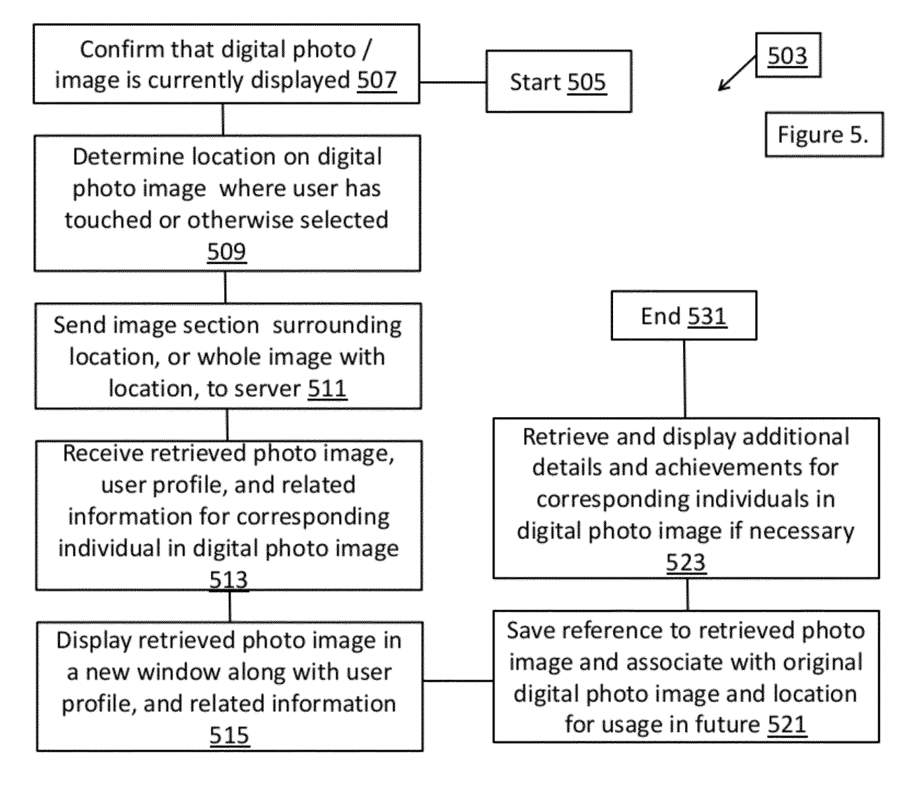

FIG. 4 is a perspective block diagram of a first interface in a server, such as in the plaque management server of FIG. 1, that provides access to various external servers and documents and services provided by external systems. The first interface 411 comprises one or more of a social network server interface 413, a picture server interface 421, a video server interface 423, a patents system interface 419, a web crawler interface 429 and a publisher's system interface 425. It also comprises a content server interface 415, and a registration interface 427. The social network server interface 413 facilitates interaction with one or more social networks to retrieve a more recent digital photo of a user, to selectively retrieve a user profile based on one or more parameters, to create a new social interaction group in an automated mode, and to send messages to one or more people. The picture server interface 421 facilitates retrieval of one or more recent pictures of a user based upon one or more parameters, such as a tag on a displayed photo, facial feature characteristics computed/stored for an individual displayed in a photo that can be used for facial recognition and retrieval of another more recent photo for that individual.

The video server interface 423 facilitates retrieval and or streaming of one or more videos. The patents system interface 419 makes it possible to retrieve patents, retrieve status of a patent, retrieve a list of patents filed by a user, retrieve a list of patents filed by other co-inventors listed on a given patents, and assemble or compute potential infringement data. The web crawler interface 429 facilitates communicating a request to a web crawler and receiving in return a collection of relevant data that is collected by an external web crawler, such as an external server 457. The publisher's system interface 425 facilitates purchase of books, retrieval of a new book cover if available for a given book, reviews for a book, book sales information, citations of a book and other publishing related information. The content server interface 415 facilitates retrieval of necessary content related to a currently displayed document, such as a PDF copy of a related document. For example, if a transcript or a graduation certificate is currently displayed on a digital plaque, a course work and training material associated with an exam, a course, a test, a certification, etc. associated with the transcript or graduation certificate displayed, is retrieved and provided for the user to review.

The registration interface 427 verifies a registration information provided for one or more users, facilitates registration of new digital plaques and their users, and facilitates management of a group of plaques, as necessary.

In one embodiment, the plaque management server that contains the first interface 411 facilitates updating is a patent award displayed, wherein the server retrieves a status for the document, the status comprising one or more of an expiry date, maintenance fees due date, assignment changes, information in continuations, potential infringement information, products that embody the patent and publications that refer to the patent.

In one embodiment, when the plaque management server facilitates display of a document that is an old digital photo comprising one or more individuals, the plaque management server receives a user selection of a region on the old digital photo, wherein the user selection comprises selection by the user of one of the one or more individuals in the old digital photo. The plaque management server then maps the user selection with specific individuals based on tags provided, facial feature characteristics computed/determined or based on other associated parameters, and then retrieves more recent photos, professional and public profiles for the individual targeted/identified, and other related data for display on the digital plaque (and for storing for subsequent access, as might be necessary).

FIG. 5 is a flow chart of an exemplary operation of the digital plaque device 111 as it displays a digital photo/image, wherein the digital photo/image is selected for display by the user. At a start block 505, the operation starts when the digital plaque device 111 solicits user inputs/instructions from a user, and receives user selection of a digital photo/image for display. Then, at a next block 507, the digital plaque device 111 confirms that a digital photo/image is currently displayed. Then, at a next block 509, the digital plaque device 111 determines a location on the digital photo/image where a user has touched (on a touch sensitive screen) or otherwise selected (such as by means of a remote control, a mouse, a digital pen, etc.). For example, the user can touch a face of an individual on the displayed digital photo/image and a region/area around that point of touch is determined and used for identifying the associated individual employing one of several possible ways. Similarly, if the user has tagged the various faces in the displayed digital photo/image, then when a user touches a face of an individual on the displayed digital photo/image, the associated tag (provided by the user, and stored by the digital plaque device 111 associating the tags with the displayed digital photo/image) is employed to retrieve a more recent photo of that individual selected.

Then, at a next block 511, the digital plaque device 111 sends the section of the image surrounding the user selected location on the digital photo/image to the plaque management server (or alternatively, a picture server) for identification of the individual and retrieval of an updated image (more recent photo, for example) along with professional and personal profiles, if they are available. In one embodiment, the entire image is sent, along with the location of user selected spot on the digital photo/image to the plaque management server.

At a next block 513, the digital plaque device 111 receives a retrieved photo/image along with a user profile (for the individual the user selected in the digital photo), and related information for the corresponding individual in the digital photo/image. Then, at a next block 515, the digital plaque device 111 displays the retrieved digital photo/image along with retrieved user profile (professional and/or persona profile) and related information (such as address, phone numbers, achievements, awards, etc.). This is done selectively employing a new window for the retrieved digital photo/image, using a sub-window, using the same window as the original digital photo/image (appending to the same window), replacing the original digital photo/image, in a pop-up window, etc.

At the next block 521, the digital plaque device 111 saves a reference to the retrieved digital photo/image and associates it with the original digital photo/image and the location of the corresponding user selected individual in the original digital photo/image for future reference, retrieval and display.

Then, at a next block 523, the digital plaque device 111 retrieves and displays additional details and achievements for the corresponding individuals in the digital photo/image if necessary. For example, the user might want (and trigger) updates for all individuals in the original photo/image, and the digital plaque device 111 retrieves updates for all the individuals tagged on the digital photo/image, and the digital plaque device 111 retrieves updates for all the individuals and provides a list of updated information for the user to review, presenting each update information (such as one set for each individual in the digital photo/image), one at a time (or all appended into one page) in a pop-up window or sub-window.

Then at a next end block 531, the operation terminates.

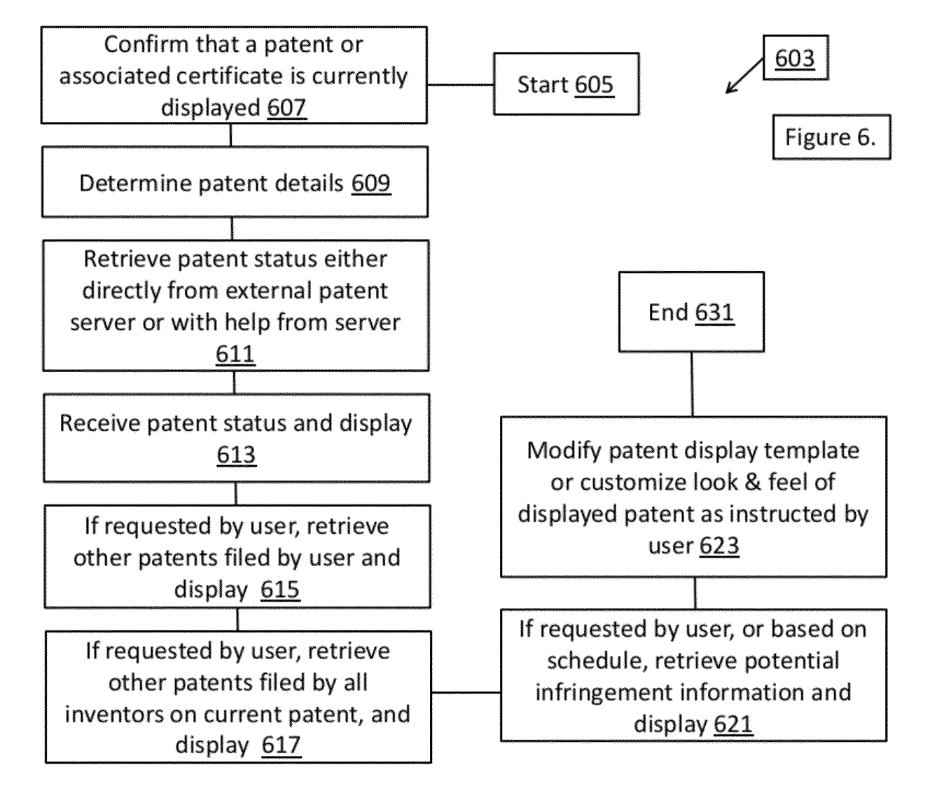

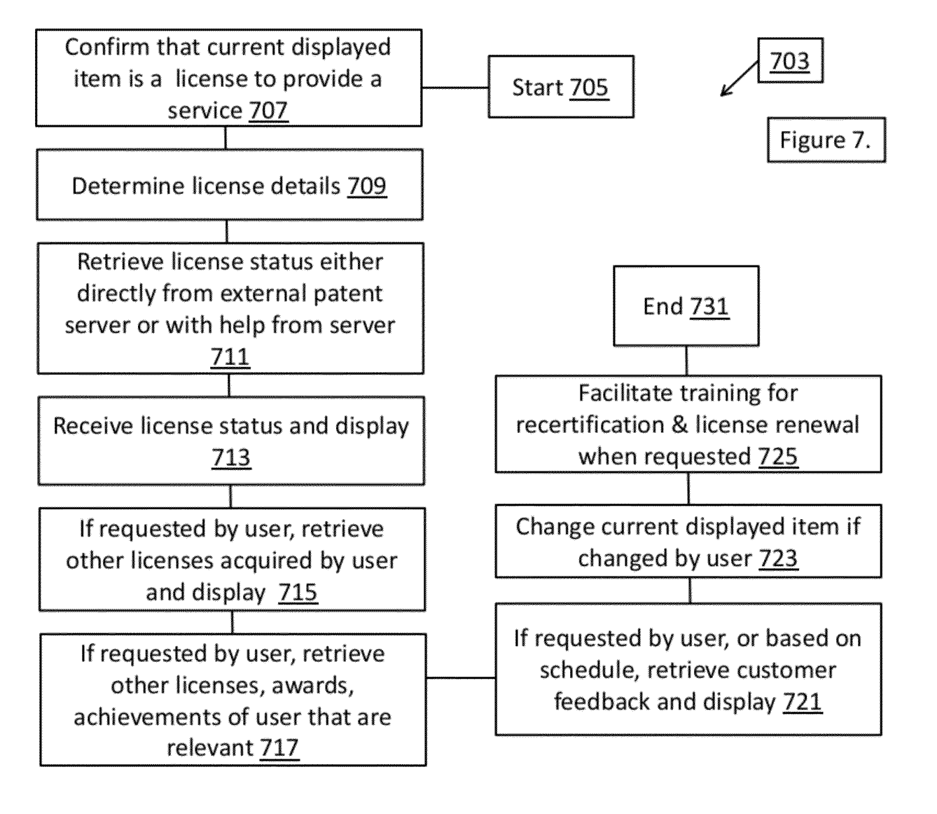

FIG. 6 is a flow chart of an exemplary operation of the digital plaque device 111 as it displays a patent, patent application or trademark. At a start block 605, the operation starts when the digital plaque device 111 solicits user inputs/instructions from a user, and receives user selection of a patent, patent application or trademark. Then, at a next block 607, the digital plaque device 111 confirms that a patent, patent application or trademark is currently displayed. Then, at a next block 609, the digital plaque device 111 determines details of the patent, patent application or trademark and displays it. Then, at a next block 611, the digital plaque device 111 retrieves, either directly from an external patent server (such as the patent server from USPTO) or with the help of the plaque management server, a patent status, patent application status or a trademark status, as applicable.

At a next block 613, the digital plaque device 111 receives a patent status and displays it. In the case of a patent application or a trademark, it receives a corresponding status information and displays it. Typically, the displayed information comprises information on fees due, expiration dates, status changes (such as change from “allowed” status to “issued status” for a patent application), list of inventors, current assignment information, etc. At a next block 615, if the user has requested retrieval of other patents, patent applications, trademarks, etc. filed by the same user, the digital plaque device 111 retrieves such information and displays it.

Then, at a next block 617, if requested by the user, the digital plaque device 111 retrieves other patents filed by all inventors on the current patent, and displays them. Then, at a next block 621, if requested by the user, or based on a schedule (previously set by user or a default schedule) the digital plaque device 111 retrieves potential infringement information and displays them. Then, at a next block 623, if initiated by the user, the digital plaque device 111 modifies the template used to display the currently displayed patent (or patent application, trademark). It lets the user customize the look and feel of the displayed patent. Then it employs the user specified template or customized look and feel to display the patent. It also stores the selected template, modified template, or customized look and feel.

Finally, the operation terminates at the end block 631.

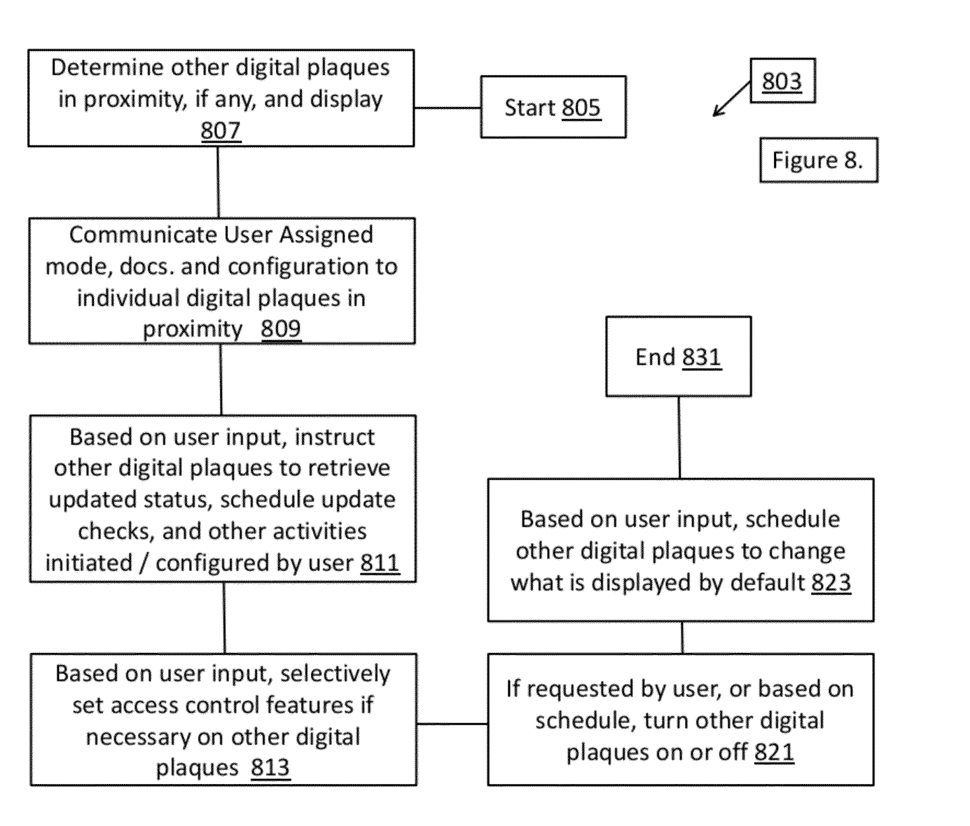

FIG. 7 is a flow chart of an exemplary operation of the digital plaque device 111 as it displays a license to provide a service or license to operate a business. At a start block 705, the operation starts when the digital plaque device 111 solicits user inputs/instructions from a user, and receives user selection of a license to provide a service or license to operate a business. Then, at a next block 707, the digital plaque device 111 confirms that license to provide a service or license to operate a business is currently displayed. Then, at a next block 709, the digital plaque device 111 determines the details of the license and displays it.

At a next block 711, the digital plaque device 111 retrieves license status either directly from an external patent server (such as a USPTO based website/server) or with help from the plaque management server. In one embodiment, it sends a request for such update information and waits to receive a response which it can subsequently display. At a next block 713, the digital plaque device 111 receives license status and displays it.

At a next block 715, if requested by the user, the digital plaque device 111 retrieves other licenses acquired by the user and displays it. Then, at a next block 717, the digital plaque device 111, if requested by the user, retrieves other licenses, awards, achievements of the current user and other users associated with that business, or other users that are relevant.

At a next block 721, when triggered by the user or based on schedule set (or default schedule), the digital plaque device 111 retrieves customer feedback and displays it. Customer feedback for a business or a service provider is saved at a website associated with the business/service provider and is retrieved by the digital plaque device 111 for display when requested by a user (displaying the license) or when designed to be part of a display comprising the license.

At a next block 723, the digital plaque device 111 facilitates changing of the currently displayed item/document, and based on user selections, the currently displayed document is changed. Then, at a next block 725, the digital plaque device 111 facilitates training for recertification and relicensing when requested by the user. For example, the digital plaque device 111 displays the recertification date for a license or the license renewal date (and associated fees) for a currently displayed license. The user might decide to retrieve additional information such as recertification requirements, training information, license renewal process and cost, etc. Such user requests are supported and associated documents are retrieved and displayed. For example, online training for recertification is provided and practice tests are provided too, if necessary and requested by the user.

Then at a next end block 731, the operation terminates.

FIG. 8 is a flow chart of an exemplary operation of the digital plaque device 111 as it interacts with other digital plaques in proximity and manages what is displayed on them. At a start block 805, the operation starts when the digital plaque device 111 is set in a mode where it can determine if any other digital plaques are currently in proximity and interact with them. Then, at a next block 807, the digital plaque device 111 determines if any other digital plaques are in proximity and displays a list of such devices to the user. It also lists or displays the currently displayed documents on the other digital plaque devices in proximity.

At a next block 809, the digital plaque device 111 communicates user assigned modes to the other digital plaques in proximity, along with specific documents and associated configuration assigned to the individual digital plaques in proximity. Then, at a next block 811, based on user input on the digital plaque device 111, it instructs the other digital plaques in proximity to retrieve updated status and display them. It also instructs them to schedule update checks (schedules for updates of various kinds based on the document types of assigned documents). It then instructs them to initiate any activities selected and configured by the user.

At a next block 813, based on user selections, the digital plaque device 111 selectively sets access control features, as necessary (based on perceived security needs by the user), on the other digital plaques in proximity. This includes setting username and passwords, for example to control access and updates to the other digital plaques in proximity. At a next block 821, if requested by the user, or based on a schedule, the digital plaque device 111 turns other digital plaques in proximity ON or OFF. Thus, the digital plaque device 111 is capable of managing the other digital plaque devices in proximity, set documents they can display, set update schedules, etc.

At a next block 823, if requested by the user, or based on a schedule, the digital plaque device 111 instructs other plaque devices to change their documents that the currently display. For example, between 8 am and 6 pm, the digital plaque device 111 instructs them to display one set of documents, and after 6 pm in the evening, it instructs them to each display a different/alternative document.

Then, at a next end block 831, it terminates operation.

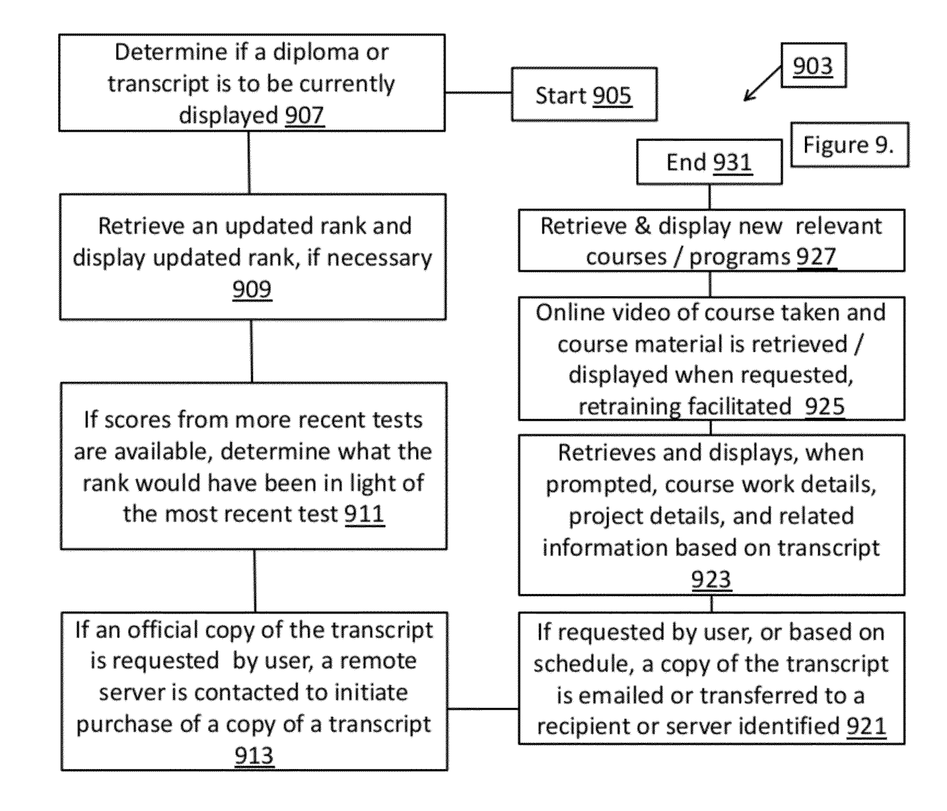

FIG. 9 is a flow chart of an exemplary operation of the digital plaque device 111 as it displays a graduation diploma, graduation award or transcript selected by a user. At a start block 905, the operation starts when the digital plaque device 111 is set in a mode where it can display a transcript and other related documents. Then, at a next block 907, the digital plaque device 111 determines if a graduation diploma, graduation award or transcript is to be currently displayed. Then, at a next block 909, the digital plaque device 111 retrieves an updated rank and displays the updated rank, if necessary. A rank is associated with some transcripts and graduation diploma and changes in rank are automatically retrieved (or when requested by user) and updates are displayed.

At a next block 911, the digital plaque device 111 checks for availability of more recent scores (by accessing external servers, such as those provided by organizations that conduct standardized tests such as, for example, GED, LSAT, PSAT, PLAN, SAT, ACT GRE, TOEFL, etc.). If it finds more recent scores, test averages and test reports, it computes a revised rank for a user in light of more recent scores, and displays the updated test scores/ranking for the user of the digital plaque device 111. For example, is a SAT transcript displayed by a user shows a Sat total score of 2380 out of a possible total of 2400, and the assigned percentile ranking for the user on the transcript is 99%, then, in light of more recent tests conducted, a revised rank can be computed and displayed for the user, that would indicate the user's percentile ranking had the user taken the test again and scored the same score of 2380.

At a next block 913, the digital plaque device 111 facilitates placing an order for additional official copies of transcripts with a remote server associated with a testing service or an education institution. If an official copy of a transcript currently displayed by a user, or of a graduation certificate, a graduation diploma, GED certificate, etc. is requested by a user, the digital plaque device 111 contacts a remote server to initiate the purchase of an official copy of the transcript/graduation certificate/a graduation diploma/GED certificate, etc.

At a next block 921, if requested by a user, or based on a schedule, a copy of the transcript is emailed to a user, or transferred to a recipient or to a server/website identified by the user. At a next block 923, the digital plaque device 111 retrieves and displays, when prompted by the user, syllabus, course work details, project details, training material, assignments, reference materials, and related information associated with the transcript currently displayed, or with the graduation certificate, a graduation diploma, GED certificate currently displayed.

Then, at a next block 925, the digital plaque device 111 retrieves and displays online video of course taken and course material associated with the transcript displayed, online training videos for retraining the user on the course work listed in the transcript, etc. Thus, retraining is facilitated by the digital plaque device 111. Then, at a next block 927, the digital plaque device 111 retrieves and displays new relevant courses/programs the user is now eligible for, based on his transcript. It also displays jobs available for the user, and jobs he is qualified for, based on that transcript/graduation certificate/a graduation diploma/GED certificate, etc. Then at the end block 931, the operation terminates.

The digital plaque device 111 effectively provides a transcript display service that allows each user to access, display, optionally print their transcripts. Some embodiments also support accessing and displaying (and optionally even printing) gradeslip copies for each exam attempt by the user from a given year to the present. For example, the user can click on “Gradeslip” button displayed next to the exam attempt items presented in a list, and the corresponding gradeslip is displayed. The user can then print them too, such as using a network printer in proximity.

In one embodiment, the digital plaque device 111 also facilitates requesting a gradeslip from an education organization (for a course taken for example). For example, it provides a form for requesting a grade slip for the last term a user completed at an educational organization, such as a University. It also provides means to order a transcript online from the education organization. The user's request for a gradeslip or for a transcript copy is forwarded to an external server associated with the educational organization after the user provides, for example, a Student ID, a first name and a last name on the form presented to the user. A gradeslip copy or a transcript copy will be received by the digital plaque device 111 unless the user has also specified that it should be sent to his current mailing address. Online copies of gradeslips are received, stored and displayed by the digital plaque device 111. From the gradeslips, for example, the user can trigger retrieval of associated coursework, syllabus, training material, assignments submitted, tests taken, etc.

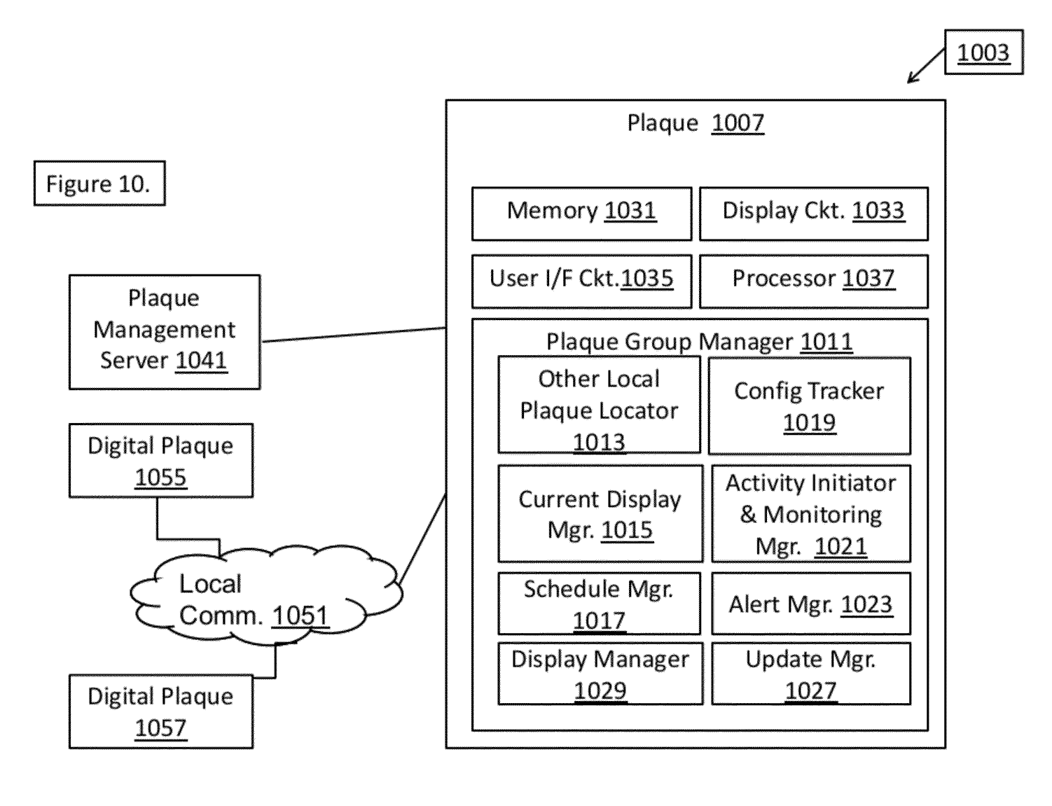

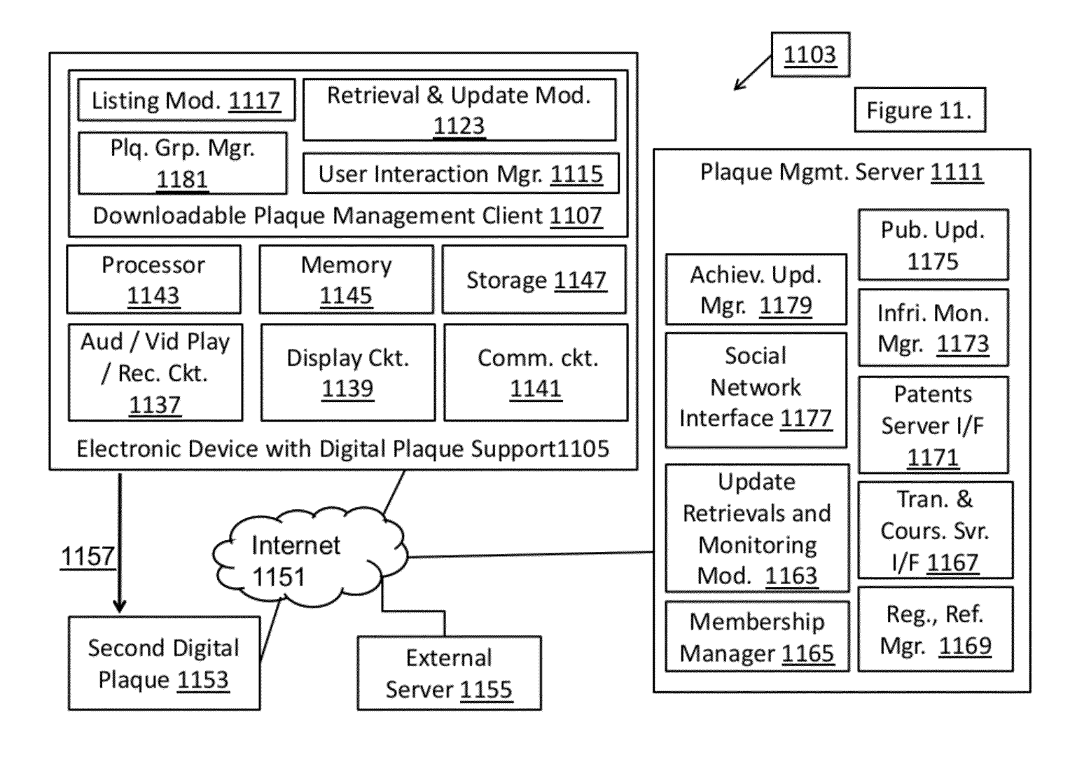

FIG. 10 is a perspective block diagram of a system 1003 comprising a plaque 1007 that is capable of not only interacting with a plaque management server 1041, but also capable of managing a plurality of other digital plaques in proximity, wherein each of the plurality of digital plaques 1055, 1057 can be assigned documents to display, updates to display, schedules to update its displayed documents and server to interact with. In general, the plaque 1007 is used to display a document, wherein the plaque 1007 is able to retrieve updates to the document and display the updated information/updated document. The plaque 1007 comprises a memory 1031, a display circuitry 1033, an user interface circuitry 1035, and a processor 1037 operably coupled to the memory 1031, the display circuitry 1033 and the user interface circuitry 1035. The plaque comprises a display screen to display the document, wherein the display screen is controlled by and managed by the display circuitry 1033.

The memory 1031 comprises executable code for causing the processor 1037 to perform a document display operation that comprises selecting a document from a collection of document or document references currently available in the memory 1031, and accessing a server (such as the plaque management server 1041) for an updated version of the document and associated status information. It also comprises executable code that facilitates retrieving the updated version of a displayed document, and associated status information from the server, and, showing the updated version and status information, if available, on a user interface screen employing the display circuitry 1033, along with the document.

The plaque 1007 also comprises a plaque group manager 1011 that facilitates interaction with and management of a group of digital plaques 1055, 1057 in a premises, including creation of a plaque group also comprising the plaque 1007. The plaque 1007 acts as a manager and manages display on others of the plaque group of plaques, updating them as necessary, sharing what is displayed on the display screen of the other plaques in the plaque group. The plaque 1007, acting on user inputs and employing the plaque group manager 1011, assigns what needs to be displayed in other plaques 1055, 1057, currently in proximity. Acting on user inputs and employing the plaque group manager 1011, the plaque 1007 provides a means to search, select and assign for display various patents, trademarks, achievement awards, transcripts and gradation certificates, photos, and videos on individual ones of the digital plaques 1055, 1057 in proximity.

The plaque group manager 1011 makes it possible to make and manage a schedule for the display of specific documents on specific ones of the plaques 1055, 1057 in the plaque group, while also enabling the specification of a time and duration for which such displays occur. It comprises a other local plaque locator 1013, a configuration tracker 1019, a current display manager 1015, an activity initiator & monitoring manager 1021, a schedule manager 1017, an alert manager 1023, a display manager 1029 and an update manager 1027.

The other local plaque locator 1013 facilitates locating other devices in proximity, with which the plaque 1007 can interact with, and manage display of documents, etc. The configuration tracker 1019 makes it possible to retrieve and track configurations of other plaques in proximity 1055, 1057. The current display manager 1015 is able to ascertain what is displayed in each of the other digital plaques 1055, 1057 in proximity. It is also able to manage what is displayed on them, and also change what is displayed on them. The activity initiator & monitoring manager 1021 facilitates initiating various activities on the other digital plaques 1055, 1057 in proximity, such as turning them ON or OFF, maintenance activities, backup and restoring documents displayed, configuration set and updates communicated. It also monitors what is displayed, how often documents displayed are changed, and how they are purchased, subscribed to, etc.

The schedule manager 1017 facilitates setting schedules of updates on the various other digital plaques 1055, 1057 in proximity. It also facilitates scheduling of maintenance activities on the various other digital plaques 1055, 1057 in proximity, including turning them ON or OFF, as necessary. The alert manager 1023 makes it possible to communicate alert messages from the plaque 1007 to the other digital plaques 1055, 1057 in proximity. Alert messages can be used to get the attention of a user to events that the user is expected to be interested in, that the user must attend to, or events that require feedback or inputs from the user. For example, an alert can be displayed on the digital plaque 1055 to indicate that a patent application displayed on the digital plaque 1055 is about to issue. An alert can be displayed on the digital plaque 1057 to indicate that a license to operate a business is about to expire, and that the user has an option to renew the license by paying a fee online, such payments facilitated by the digital plaque 1057 or the plaque 1007.

The display manager 1029 makes it possible to determine what is displayed on the other digital plaques 1055, 1057 in proximity, and also to modify/update what is displayed. It facilitates management of various activities in each of the other digital plaques 1055, 1057 in proximity, and it provides user interaction screens, buttons, touch sensitive operations, etc. as necessary to help a user manage one or more of the other digital plaques 1055, 1057 in proximity using the plaque 1007 as the managing entity.

The update manager 1027 determines the type of update activity that needs to be assigned to the various (same or different) documents displayed on the other digital plaques 1055, 1057 in proximity. It makes it possible, if necessary, to schedule updates at the plaque management server 1041 for all the other digital plaques 1055, 1057 in proximity. For example, it facilitates retrieval of new updated documents (more recent version of these documents if necessary) by the plaque 1007 for display on the other digital plaques 1055, 1057 in proximity.

FIG. 11 is a perspective block diagram of a system 1103 comprising an electronic device with digital plaque support 1105 that is capable of not only displaying updateable documents, interacting with a plaque management server 1111, but also interacting with a second digital plaque 1153. The electronic device with digital plaque support 1105 comprises a downloadable plaque management client 1107, a processor 1143, a memory 1145, a storage 1147, an audio/video player and recording circuitry 1137, a display circuitry 1139 and a communication circuitry 1141. The downloadable plaque management client 1107 facilitates interaction with the plaque management server 1111, in addition to facilitating display of documents, update of documents, purchase of copies of the document, etc. The plaque management server 1111 has features and functionality similar to the features and functionality described for the plaque management server 107 described in FIG. 1.

The electronic device with digital plaque support 1105 is a TV in one embodiment and a laptop in another embodiment. It is a monitor for a computer in another embodiment. It is an electronic poster board in yet another embodiment.

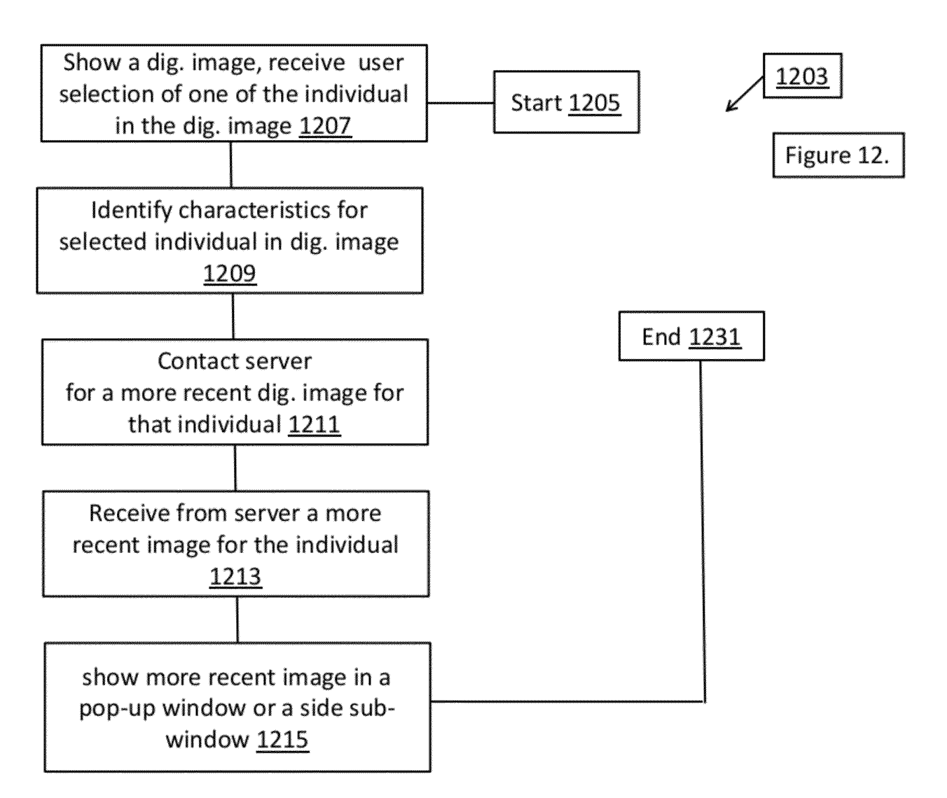

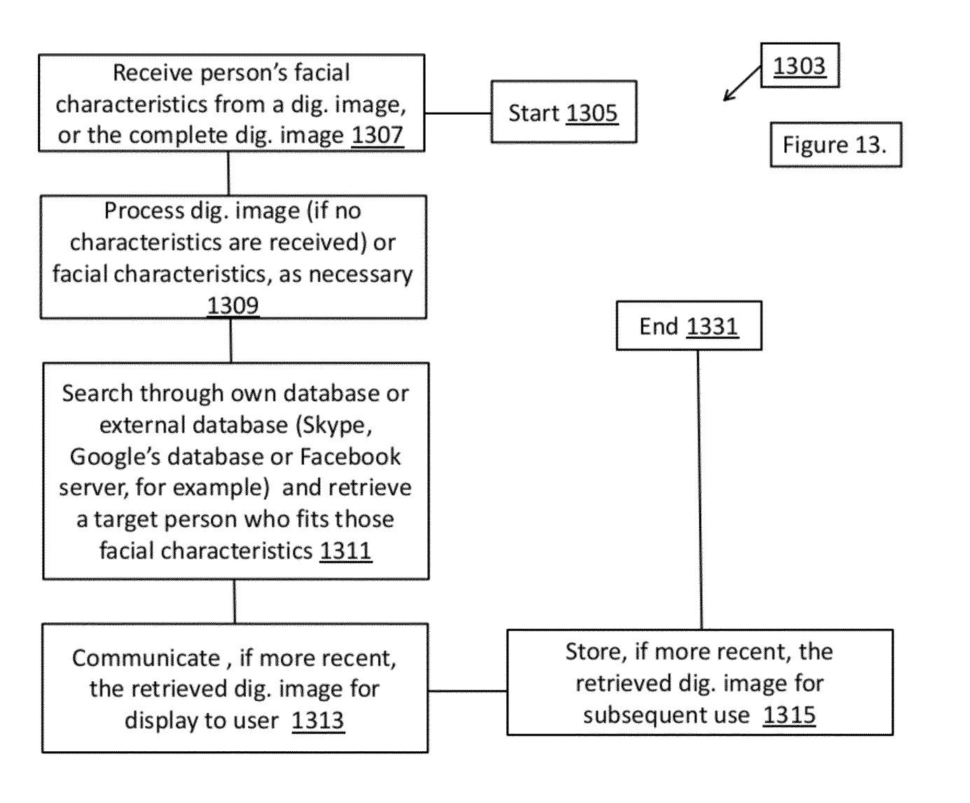

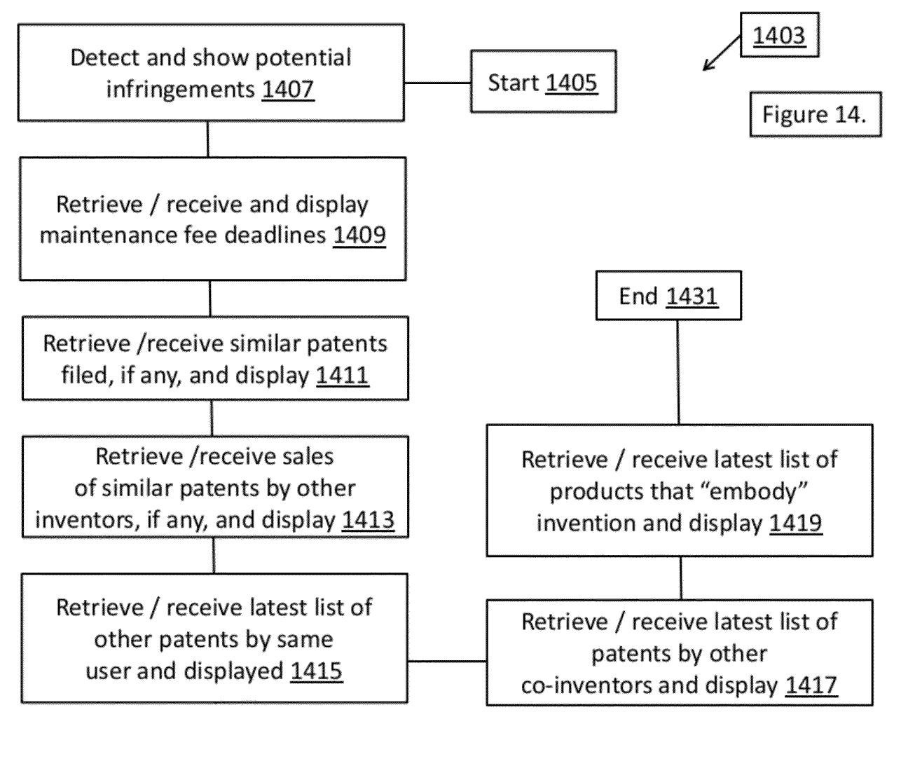

FIG. 12 is a flow chart of an exemplary operation of the digital plaque as it displays a document, wherein the document is a digital photo/image and wherein the digital plaque is capable of identifying an individual shown in the digital photo/image and retrieving a recent photo/image of that individual in addition to professional and personal profiles of that individual. The operation starts at a start block 1205 when the user selects (for example, after searching or after picking from a list of documents) a digital photo/image for display on the digital plaque. Then, at a next block 1207, the digital plaque shows the digital photo/image and receives a user selection of one of the individuals in the digital photo/image. The digital plaque provides user interface elements to solicit user selections, to facilitate selection by the user of one or more individuals shown in the digital photo/image, and means to tag those individuals by the user, if necessary, the tags being used selectively by the digital plaque to retrieve more recent digital photo and profiles (personal and professional, for example) for the one or more individuals selected by the user.

At a next block 1209, the digital plaque identifies characteristics for the selected individual in the digital photo/image. Then, at a next block 1211, the digital plaque contacts a server, such as the plaque management server or a social network server, for a more recent digital photo/image for that individual. Then, at a next block 1213, the digital plaque receives from the server a more recent digital photo/image for that individual. At a next block 1215, the digital plaque shows the more recent digital photo/image received in a pop-up window, or a sub-window along with the original digital photo/image. If more than one newer/more recent digital photos/images are retrieved, then a scrollable list of these retrieved digital photos/images are presented to the user for review and optional storage.

Finally, the operation terminates at the end block 1231.

FIG. 13 is a flow chart of an exemplary operation of the server, such as a picture server or a plaque management server, wherein the server is capable of processing a portion of the displayed digital photo/image, or a whole digital photo/image in order to identify the selected individual(s) and retrieve newer/more recent digital photos and profiles for these selected individuals. The operation starts at a start block 1305 when the server receives a request from the digital plaque to retrieve newer/more recent digital photos and profiles for one or more user selected individuals. Then, at a next block 1307, the server receives a person's facial characteristics (extracted from a digital photo/image) or a complete digital image comprising locations/regions identified as locations of facial features of one or more individuals.

At a next block 1309, the sever processes the digital photo/image if facial characteristics are not received, and then determines the facial characteristics for the one or more individuals. If the server has received facial characteristics, then it does not have to conduct this processing. Then at a next block 1311, the server searches through its own database or an external database (such as a database of images and user profiles stored by the Shype service, Google's database of images, Facebook server that stores user photos, etc.) and identifies a target person whose facial characteristics fits the ones the server is searching for. The server retrieves the newer/more recent digital photos/images and user profiles (professional and personal) for that target person(s). At a next block 1313, the server communicates the newer/more recent digital photos/images and user profiles (professional and personal) for that target person(s) to the digital plaque for display to the user.

At a next block 1315, the server stores the newer/more recent digital photos/images and user profiles (professional and personal) retrieved for that target person(s) in a local storage/database for subsequent access (such as during a subsequent update check by the digital plaque). Then, at a next end block, the operation terminates.

FIG. 14 is a flow chart of an exemplary operation of the digital plaque device 111, when it displays a patent award (such as a patent granted by the USPTO), as the digital plaque retrieves updated documents, infringement information, etc. The operation starts at a start block 1405 when the user selects a patent for display on the digital plaque device 111. At a next block 1407, the digital plaque device 111 detects and shows potential infringement information. For example, the digital plaque device 111 employs the services of the plaque management server to retrieve product information from trade magazines, journals, online websites of companies, etc. to determine potential infringements by new products introduced into the market.

Then, at a next block 1409, the digital plaque device 111 retrieves (or receives from the plaque management server or from a patent system server) maintenance fee deadline information for the displayed patent. It also displays screens that help the user pay the maintenance fees due for the patent. At a next block 1411, the digital plaque device 111 retrieves/receives similar patents filed, if any, by some other inventor. It displays such information either when requested by the user, or periodically if the user has setup such scheduled displays.

At a next block 1413, the digital plaque device 111 retrieves/receives sales information on similar patents or related patents by other inventors, if any and displays them to the user. Then, at a next block 1415, the digital plaque device 111 retrieves or receives the latest list of other patents, patent applications, trademarks, trademark applications, published articles written by/filed by the same user, and displays them. At a next block 1417, the digital plaque device 111 retrieves/receives the latest list of patents or patent applications filed by other co-inventors of the currently displayed patent or patent application and displays them. Then, at a next block 1419, the digital plaque device 111 retrieves or receives the latest list of products that embody or incorporate the inventions described in the patent or patent application currently displayed, and displays that list.

Finally, at a next end block 1431, the operation terminates.

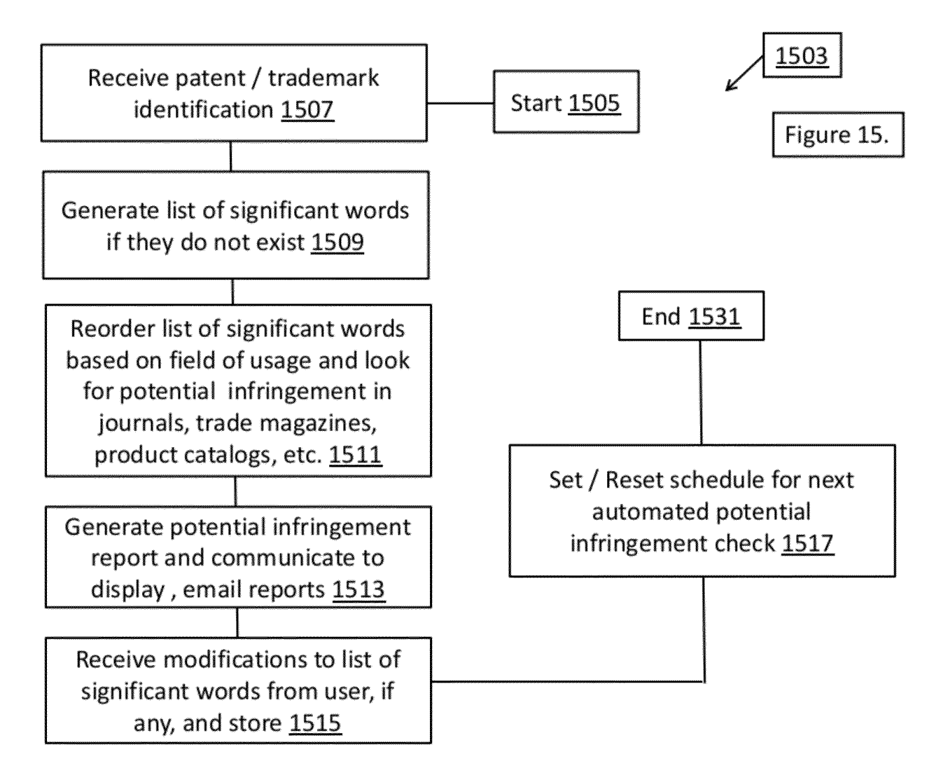

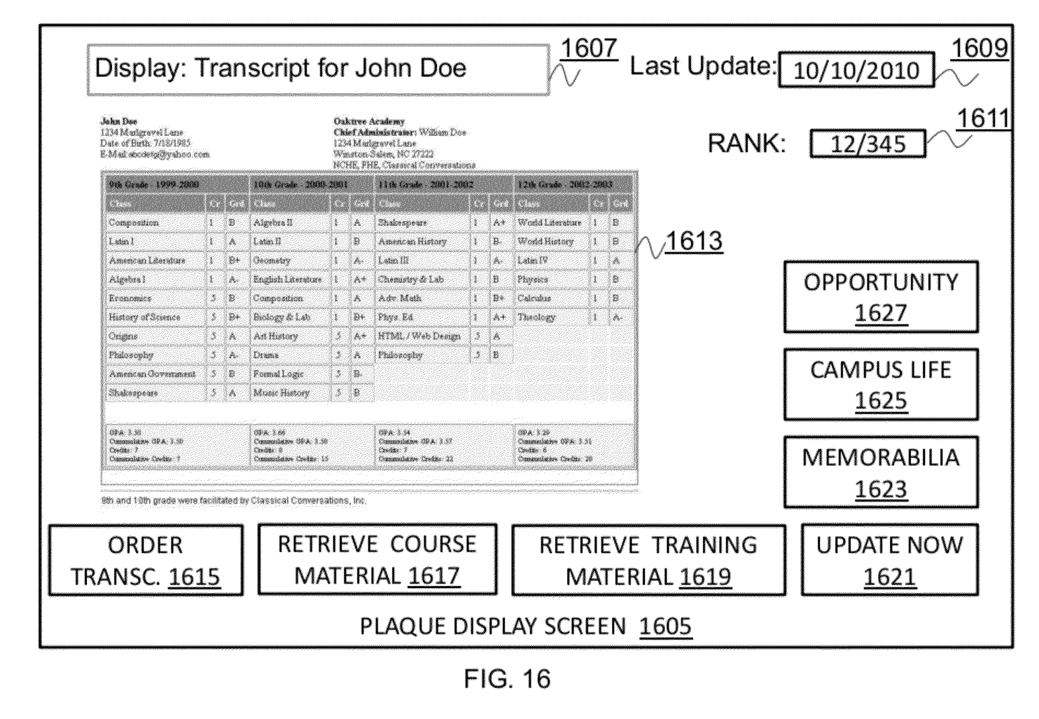

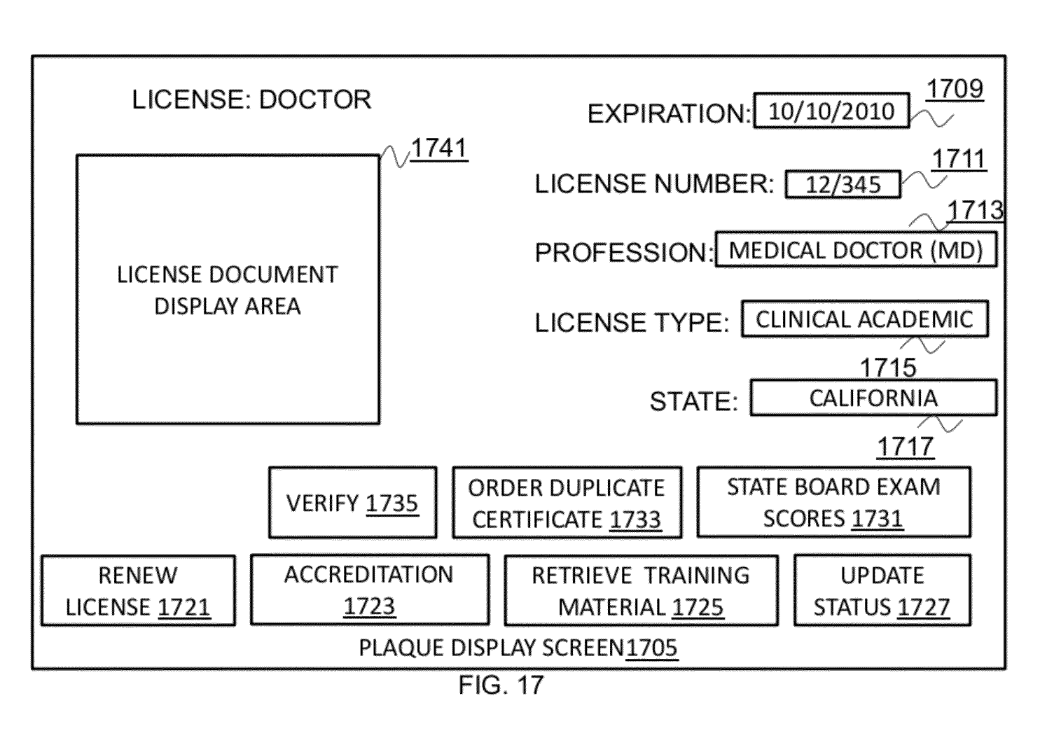

FIG. 15 is a flow chart of an exemplary operation of the digital plaque device 111 as it retrieves patent infringement information employing a technique that generates a list of significant words that is the used to retrieve product information, product news that hint at potential infringement. The operation starts at a start block 1505 when the user selects a patent or trademark for display on digital plaque device 111. Then, at a next block 1507, digital plaque device 111 receives a patent or trademark identification and details for displaying it. At a next block 1509 digital plaque device 111 generates a list of significant words, if they do not yet exist, for that patents, based on, for example, its title, an abstract, claims and other relevant sections. Then, at a next block 1511, digital plaque device 111 prepares information that it uses to search for new products and services covered in trade magazines, journals, online product information websites, etc. For example after determining a relevant/significant field of science or engineering that a trade magazine or journal covers, the generated list of significant words are rearranged so as to add relevance to those phrases/terms/words that are likely to be more useful in searching for the infringing products and services in that specific area of science/engineer technologies. Therefore, before searching for infringing products employing the significant words in any given magazine/journal/website, it is first rearranged for that specific magazine/journal/website to incorporate (or customize) field specific relevance information or weightage. For example, for a patent dealing with communication systems, the term “frames” is likely to be significant. However, while searching for “frames” in a trade magazine dedicated to video technology (where frames per second is a common phrase) is of less use and of little importance, searching for occurrences of “frames” in a magazine of network protocols is more useful, as the use of frames as in “frames of data” is more likely to guide one towards potential infringement. Thus, a modified list of significant words is created, one for each magazine/journal/website, which is then used to search for products or services that are likely to be infringing.

Then, at a next block 1513, the digital plaque device 111 generates potential infringement report and displays it to the user. In one related embodiment the generation of significant words in the block 1509, the reordering of the list of significant words in the block 1511, and the generation of potential infringement report in the block 1513 are all executed in the plaque management server, which then communicates the generated potential infringement report to the digital plaque device 111.

Then, at a next block 1515, the digital plaque device 111 receives the modifications to the list of significant words from the user, if any, and stores it. For example the user might choose to add to, delete from or modify the order of words in the list of significant words. The modified list of significant words is stored.

At a next block 1517, the digital plaque device 111 sets or resets a schedule for the next automated potential infringement check. Then, at the next end block 1531, the operation terminates.

In one embodiment, the exemplary operation described here for the digital plaque device 111 is incorporated into the plaque management server, which generates the list of significant words, modifies it (by reorganizing it as necessary) for searching for infringement in various magazines, journals, websites, etc., then creates an infringement report and then sends it to the digital plaque device 111 for display to the user.

In one embodiment, the plaque management server is a cloud based server installation that supports a plurality of users, each user employing a plurality of digital plaques at a user residence or user premises, wherein the plurality of digital plaques interact with each other and are communicatively coupled when they are in vicinity/proximity to each other. The plaque management server is a multi-tenant hosted/managed server, using which each of the users can manage their set of digital plaques remotely, while accessing all the services provided by the plaque management server from each of the set of digital plaques that they have deployed in their user residences/user premises.

In one embodiment, the plaque management server is integrated into a NAS used in a residence/premises of a user, wherein the NAS not only supports storage of documents and retrieval from multiple digital plaques in proximity with the NAS, but also supports retrieval of updates for the documents presented/displayed on the multiple digital plaques in proximity.

FIG. 16 is a perspective block diagram of an exemplary plaque display screen 1605 provided by the digital plaque device 111 when it displays a transcript in a transcript display area 1613 on the screen, such as a transcript 1607 for a high school student. When the plaque display screen 1605 displays the transcript 1607, it provides several buttons that a user can select from, to trigger various useful activities such as ordering copies of the transcript, retrieving course materials, retrieving training materials, requesting updates, etc. Specifically, the plaque display screen 1605 provides an order transcripts button 1615 to place orders to purchase copies of the displayed transcript or to have copies mailed/sent to one or more companies/educational organizations, a retrieve course material button 1617 that facilitates retrieval of all (or a subset) of course descriptions, course materials for the courses listed in the transcript and a retrieve training material button 1619 that facilitates retrieval (and display, if necessary) and storage of training material for one or more courses referenced in the transcript displayed. It also comprises an update now button that triggers a status update check in order to display updated status such as a rank 1611, etc. In addition, the plaque display screen 1605 presents a memorabilia button 1623 that facilitates purchasing school memorabilia and tickets to sporting events, a campus life button 1625 that retrieves and displays information, videos, reference material for a typical campus experience on the campus of the educational organization associated with the transcript. An opportunity 1627 button retrieves and displays educational opportunities, training opportunities and job opportunities in a local region as well across the nation, for the student whose transcript is currently being displayed. Other buttons are also contemplated, such as a print button, and a share button.

The transcript is displayed in the transcript display area 1613 in the plaque display screen 1605 provided by the digital plaque device 111. In one embodiment, an audio message and a song/music, such as a song of the education organization/alma mater (that alumni seem to know) is automatically played when the transcript is displayed.

FIG. 17 is a perspective block diagram of an exemplary plaque display screen 1705 provided by the digital plaque device 111 when it displays a license to operate, such as a license obtained by a doctor to operate a medical practice. The license is displayed in a license document display area 1741. In addition, an expiration date field 1709, a license number field 1711, a profession field 1713, a license type field 1715 and a state field 1717 provide specific details of the license document displayed in the a license document display area 1741.

The plaque display screen 1705 comprises a license verify button 1735 that conducts online license verification, a renew license button 1721 that facilitates online renewal of a license or a online submission of a license renewal form, an accreditation button 1723 that facilitates retrieval of the accreditation of the practitioner whose license is displayed, and a retrieve training material button 1725 that retrieves training material for a license exam, certification exam or an accreditation exam, as appropriate. In addition, the plaque display screen 1705 presents an update status button 1727 to initiate an update status activity, an order duplicate certificate button 1733 that facilitates obtaining a certified copy of a license document, and a state board exam scores button 1731 that retrieves and displays scores from a state board exam last taken by the practitioner (doctor for example) with the displayed license. Other types of buttons are also contemplated.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

As one of ordinary skill in the art will appreciate, the terms “plaque” and “digital plaque” as may be used herein, comprise a wall mountable or a table mountable display screen made from LCD screens (thin film for example), LED screens, OLED screens, etc. that can be put up on a wall, or installed on a flat surface like a table top, desk etc. As one of ordinary skill in the art will also appreciate, such digital plaques can be managed by a user using an associated remote control, soft buttons and menu items displayed, physical buttons, keyboard, a game controller with joystick, voice commands (where a voice recognition software tool is available), gesture recognition tool, or using touch screen commands on a touch sensitive screen available/deployed on the digital plaque.

As one of ordinary skill in the art will appreciate, the terms “user interaction circuitry” as may be used herein, include user interaction means implemented through use of user interaction chipsets, associated wiring, user data entry means (such as hardkeys, soft keys, touch-sensitive input circuits, etc.) and corresponding firmware, drivers and software.

As one of ordinary skill in the art will appreciate, the updateable document that is displayed by the digital plaque can also be a poster, an advertisement, a travel brochure, and other types of documents that people typically get framed and hang on a wall.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1) An plaque to display a document, wherein the document can change status, the plaque comprising:
a memory;
a display circuitry;
an user interaction circuitry;
a communication circuitry;
a processor operably coupled to the memory, the display circuitry, the
user interaction circuitry and the communication circuitry;
a retrieval and update module that is capable of retrieving the document from a server, wherein the document is a digital image, a video, an audio, a textual item, or a combination of these;
wherein the memory comprises executable code for causing the processor to perform operations comprising:
displaying the document;
updating the document employing an update data received or replacing the document employing a replacement document received;
displaying document status as and when they are received;
retrieving another document for display based on a first user selection of an item presented in the document or second user selection of a region of the displayed document;
presenting the another document, selectively along with the document or separately in a new window; and
selectively scheduling, based on a document type, automatic retrieval of status and updates for the document.

2) The plaque of claim 2 wherein the document is a patent award, the status displayed comprises one or more of an expiry date, maintenance fees and due date, assignment changes and filing of continuations.

3) The plaque of claim 2 wherein the status information also comprises potential infringement information, products that embody the patent and publications that refer to the patent.

4) The plaque of claim 1 wherein the document is an old digital photo comprising one or more individuals, the user selection of a region comprises selection by the user of one of the one or more individuals in the old digital photo, and the another document is an more recent digital image for that one of the one or more individuals.

5) The plaque of claim 4 wherein the more recent digital image is retrieved from one of a social interaction network accessible over the Internet, a picture server accessible over the Internet, a database and a network storage device.

6) The plaque of claim 1 wherein the document is a license certificate, the user selection comprises a request to retrieve and display associated achievements awards, accreditation details, license renewal information, permits related information and relicensing requirements.

7) The plaque of claim 1 wherein the document is a transcript, the user selection comprises identification of one of the courses listed in the transcript, and the another document comprises a coursework details, corresponding course materials, information on additional related courses that the user is eligible for, and a signup form for additional related courses.

8) The plaque of claim 1 wherein the document is a transcript, a certification of achievement, a graduation award certificate that optionally includes a rank data, a document that certifies passing of a test, a document certifying the acquisition of some skills or a diploma, the plaque further comprising:
a transcript and rank update manager, that, employing the retrieval and update module, updates the document and the rank data;
the transcript and rank update manager, employing the retrieval and update module, retrieves at least one digital image of an alma mater campus, at least one video of the alma mater campus, an music associated with the alma mater and a description of the alma mater campus life, in response to a user selection that comprises an instruction to play an alma mater information; and
the plaque playing the alma mater song, if any, while displaying the at least one digital image and the at least one video.

9) The plaque of claim 8 wherein the transcript and rank update manager displays alma mater memorabilia and tickets to sports events conducted by the alma mater and provides the user an opportunity to purchase them online by placing an order.

10) The plaque of claim 1 wherein the document is a digital photo comprising one or more individuals, the user selection comprises an instruction to automatically create a social interaction group at a social interaction network, in response to which the plaque interacts with a social group interaction system to automatically setup and configure the social interaction group and communicates a reference to the social interaction group to the one or more individuals.

11) The plaque of claim 1 wherein the displaying the document, the updating the document, replacement of a document, displaying document status as and when they are received, retrieving another document for display based on user, presenting the another document, and selectively scheduling are all conducted or otherwise facilitated by a server communicatively coupled to the plaque, with the plaque providing necessary user inputs to the server for each of these operations.

12) The plaque of claim 1 wherein displaying the document, updating the document, replacement of a document, displaying document status as and when they are received, retrieving another document for display based on user selection, presenting the another document, and selectively scheduling automatic retrieval of status and updates are all conducted, managed or otherwise facilitated by an electronic tablet device communicatively coupled to the plaque, with the plaque receiving necessary user inputs from the electronic tablet device for each of these operations.

13) The plaque of claim 1 further comprising:
a plaque group manager that facilitates interaction with, and management of, a plurality of other plaques in proximity with the plaque; and
the plaque group manager employing the communication circuitry or subsets thereof to interact with the each of the a plurality of other plaques, determine their current configuration, specify what is to be displayed, and manage whatever is displayed on each of the a plurality of other plaques.

14) The plaque of claim 13 wherein the plaque group manager shares a currently displayed document with the plurality of other plaques in proximity.

15) A server that is communicatively coupled to the Internet and accessible over the Internet, the server comprising;
a communication interface for interactions with a plaque;
a first interface to interact with an external system or external server to request document updates and receive update information in return;
the server facilitating retrieval of document employing the first interface for display on the plaque wherein the document comprises a digital image, a video, an audio, a textual item, or a combination of these;
the server updating the document currently displayed on the plaque;
the server facilitating the replacement of the document currently displayed on the plaque;
the server providing a document status to the plaque when requested;
the server retrieving another document for display on the plaque based on user selection of an item presented in the document or user selection of a region of the displayed document; and
the server selectively scheduling, based on a document type, automatic retrieval of status and updates for the document that is displayed on the plaque.

16) The server of claim 15 wherein the first interface comprises one or more of the following modules:
a social network server interface that facilitates interaction with one or more social networks to retrieve a more recent digital photo of a user, to selectively retrieve a user profile based on one or more parameters, to create a new social interaction group in an automated mode, and to send messages to one or more people;
a picture server interface that facilitates retrieval of one or more recent pictures of a user based upon one or more parameters;
a video server interface that facilitates retrieval and or streaming of one or more videos;
a patents system interface that makes it possible to retrieve patents, retrieve status of a patent, retrieve a list of patents filed by a user, retrieve a list of patents filed by other co-inventors listed on a given patents, and assemble or compute potential infringement data,
a web crawler interface that facilitates communicating a request to a web crawler and receiving in return a collection of relevant data that is collected by an external web crawler;
a publisher's server interface that facilitates purchase of books, retrieval of a new book cover if available for a given book, reviews for a book, book sales information, citations of a book and other publishing related information;
a content server interface that facilitates retrieval of necessary content related to a currently displayed document; and
a registration interface that verifies registration information for one or more users, facilitates registration of new plaques and their users, and facilitates management of a group of plaques.

17) The server of claim 15 wherein the document that the server facilitates updating is a patent award, wherein the server retrieves a status for the document, the status comprising one or more of an expiry date, maintenance fees due date, assignment changes, information in continuations, potential infringement information, products that embody the patent and publications that refer to the patent.

18) The server of claim 15 wherein the document is an old digital photo comprising one or more individuals, the server comprising:
the server receives a user selection of a region on the old digital photo, wherein the user selection comprises selection by the user of one of the one or more individuals in the old digital photo;
the server retrieves another document that is an more recent digital image comprising the one of the one or more individuals; and
the server replaces the old digital photo with the more recent digital image.

19) The server of claim 18 wherein the more recent digital image is retrieved from a social interaction network employing the social network server interface.

20) The server of claim 16 wherein the document is a license certificate, the server receives a user selection from the plaque that comprises a request to retrieve and communicate associated achievements awards, accreditation details, and relicensing information, and wherein the server retrieves the requested information and communicates them to the plaque.

21) The server of claim 15 wherein the server is also communicatively coupled to an electronic device with plaque support that is capable of displaying a document, displaying a status of the document, updating the document, replacing the document, retrieving information related to the document and purchasing one or more original copies of the document.

22) A plaque to display a document, the plaque comprising:
a memory;
a display circuitry;
a user interface;
a processor operably coupled to the memory, the display circuitry and the user interface;
wherein the memory comprises executable code for causing the processor to perform a document display operation that comprises:
selecting a document from a collection of documents or document references currently available in the memory;
accessing a server for an updated version of the document and associated status information;
retrieving the updated version of the document and status information from the server; and
showing the updated version of the document and status information, if available, on a user interface screen employing the display circuitry, along with the document.

23) The plaque of claim 22 further comprising:
a plaque group manager that facilitates interaction with and management of a group of plaques in a premises, including creation of a plaque group also comprising the plaque;
the plaque acts as a manager and manages display on others of the plaque group of plaques, updating them as necessary, sharing what is displayed on its screen with other plaques in the plaque group;
the plaque, acting on user inputs and employing the plaque group manager, assigns documents needs to be displayed in other plaques of the plaque group currently in proximity; and
the plaque acting on user inputs and employing the plaque group manager, provides a means to search, select and assign for display various documents for at least one of the of the plaques in the plaque group in proximity, wherein the various documents comprise of patents, trademarks, achievement awards, transcripts and gradation certificates, licenses, book covers, photos, and videos.

24) The plaque of claim 23 further comprising:
the plaque group manager makes it possible to create and manage a schedule for display of specific documents on specific ones of the plaques in the plaque group, while also enabling the specification of a time and duration for which such displays occur.
